(19) United States
(12) Patent Application Publication
(10) Pub. No.: US 2013/0236781 A1
(43) Pub. Date: Sep. 12, 2013

(54) NEGATIVE ELECTRODE FOR SECONDARY BATTERY AND SECONDARY BATTERY

(71) Applicant: SEMICONDUCTOR ENERGY LABORATORY CO., LTD., Atsugi-shi (JP)

(72) Inventors: Teppei OGUNI, Atsugi (JP); Ryota Tajima, Isehara (JP)

(73) Assignee: Semiconductor Energy Laboratory Co., Ltd., Atsugi-shi (JP)

(21) Appl. No.: 13/769,855

(22) Filed: Feb. 19, 2013

(30) Foreign Application Priority Data
Mar. 6, 2012 (JP) 2012-049232

(51) Int. Cl. H01M 4/62

(52) U.S. Cl. CPC H01M 4/622
USPC 429/211; 216/13

(57) ABSTRACT

A negative electrode for a secondary battery and a secondary battery using the negative electrode are provided. The negative electrode includes a current collector, an active material layer, and a high molecular material layer. The current collector includes a plurality of protrusion portions extending substantially perpendicularly and a base portion which includes the same material as the plurality of protrusion portions and is connected to the plurality of protrusion portions. The protrusion portions and the active material layer covering the protrusion portions form negative electrode protrusion portions. The base portion and the active material layer covering the base portion form a negative electrode base portion. Part of side surfaces of the negative electrode protrusion portions including basal portions thereof and a top surface of the negative electrode base portion are covered with the high molecular material layer.

### BACKGROUND OF THE INVENTION

1. Field of the Invention

The present invention relates to a negative electrode for a secondary battery and a secondary battery.

2. Description of the Related Art

In recent years, with the advance of environmental technology, power generation devices (e.g., solar power generation devices) having lighter environmental load than conventional power generation methods have been actively developed. Concurrently with the development of power generation technology, development of power storage devices, for example, secondary batteries such as lithium secondary batteries, lithium-ion capacitors, and air cells has also been underway.

In particular, demand for secondary batteries have rapidly grown with the development of the semiconductor industry, as in the cases of electronic appliances, for example, portable information terminals such as cellular phones, smartphones, and laptop computers, portable music players, and digital cameras; medical equipment; and next-generation clean energy vehicles such as hybrid electric vehicles (HEV), electric vehicles (EV), and plug-in hybrid electric vehicles (PHEV), and the secondary batteries are essential for today's information society as a chargeable energy supply source. Especially in the case of applications for electric vehicles or home electrical appliances such as refrigerators, batteries with higher capacity and higher output are desirable.

A negative electrode used in such a secondary battery (hereinafter “negative electrode for a secondary battery”) is manufactured in such a manner that a layer containing an active material (hereinafter “active material layer”) is formed over one surface of a current collector. Black lead that can occlude and release ions serving as carriers (hereinafter “carrier ions”) is a conventional material used as a negative electrode active material. In other words, the negative electrode has been manufactured in such a manner that black lead which is a negative electrode active material, carbon black as a conductive additive, and a resin as a binder are mixed to form slurry, the slurry is applied over a current collector, and the current collector is dried.

In contrast, in the case of using silicon or silicon doped with phosphorus as a negative electrode active material, carrier ions about four times as much as those in the case of using carbon can be occluded, and the theoretical capacity of a silicon negative electrode is 4200 mAh/g, which is significantly higher than a theoretical capacity of a carbon (black lead) negative electrode of 372 mAh/g. For this reason, silicon is an optimal material for increasing capacity of a secondary battery, and secondary batteries using silicon as a negative electrode active material have been actively developed today in order to increase the capacity.

As the amount of occluded carrier ions increases, however, the volume of silicon greatly changes due to occlusion and release of carrier ions in charge and discharge cycles, resulting in lower adhesion between a current collector and silicon and deterioration of battery characteristics due to charge and discharge. Further, in some cases, a serious problem is caused in that silicon is deformed and broken to be peeled or pulverized, so that a function as a battery cannot be maintained.

In Patent Document 1, for example, as a negative electrode active material, a layer formed using microcrystalline silicon or amorphous silicon is formed in a columnar shape or in a powder form over a current collector formed using copper foil or the like with a rough surface, and a layer formed using a carbon material such as black lead which has lower electric conductivity than silicon is provided over the layer formed using silicon. This makes it possible to collect current through the layer formed using a carbon material such as black lead even if the layer formed using silicon is separated; thus, deterioration of battery characteristics is reduced.

### REFERENCE

[Patent Document 1] Japanese Published Patent Application No. 2001-283834

### SUMMARY OF THE INVENTION

However, in Patent Document 1, when the negative electrode active material layer has either a columnar shape or a powder form and charge and discharge are repeated more than 10 cycles, which is described in the document, expansion and contraction of the volume cannot be avoided as long as the negative electrode active material occludes and releases carrier ions. Thus, deformation and breakage of the negative electrode active material layer cannot be prevented, which makes it difficult to maintain the reliability of a battery.

In particular, in the case where silicon which is a negative electrode active material is used as a columnar structure body, the columnar structure body might be fallen from the current collector because of repeated charge and discharge, and significant reductions in charge and discharge capacity and discharge speed might be caused because of an increase in the number of cycles. This results from the fact that a portion where the current collector is in contact with the columnar structure body is limited to a bottom surface of the columnar structure body as well as expansion and contraction of the entire columnar structure. In Patent Document 1, in view of the above, current is collected in the layer formed using black lead on the assumption that silicon which is an active material is separated from the current collector. Thus, the above structure has a problem in ensuring reliability in terms of cycle characteristics.

Further, in the case where a layer formed using silicon provided over a current collector is covered with a layer formed using black lead, the thickness of the layer formed using black lead increases, for example, submicron to micron, which results in a reduction in the amount of carrier ions transferred between an electrolyte solution and the layer formed using silicon. On the other hand, when an active material layer containing silicon powder is covered with thickly formed black lead, the amount of silicon contained in an active material layer is reduced because of the thick black lead. Consequently, the amount of reaction between silicon and carrier ions is reduced, which causes a reduction in charge and discharge capacity and makes it difficult to perform high-speed charge and discharge of a secondary battery.

Furthermore, since only the bottom portion of the columnar structure body of the active material described in Patent Document 1 is firmly attached to the rough surface of the current collector, the adhesion strength between the current collector and the active material is extremely low. Thus, the columnar structure body is easily separated from the current collector because of expansion and contraction of silicon.

In view of the above, one embodiment of the present invention provides a negative electrode for a secondary battery which has high charge and discharge capacity, can be charged and discharged at high speed, has little deterioration of battery characteristics due to charge and discharge, and has high reliability and a secondary battery using the negative electrode.

One embodiment of the present invention is a negative electrode for a secondary battery including a current collector which includes a plurality of protrusion portions extending substantially perpendicularly and a base portion which is formed using the same material as the plurality of protrusion portions and connected to the plurality of protrusion portions; an active material layer; and a high molecular material layer. The protrusion portions and the active material layer covering the protrusion portions form negative electrode protrusion portions, and the base portion and the active material layer covering the base portion form a negative electrode base portion. Part of side surfaces of the negative electrode protrusion portions including basal portions thereof and a top surface of the negative electrode base portion are covered with the high molecular material layer.

In the current collector, the base portion is much thicker than the protrusion portions and functions as an electrode terminal. The plurality of protrusion portions is formed on a surface of the base portion, has a function of increasing the surface area of the current collector, and also functions as cores of the active material layer. The plurality of protrusion portions extends in a direction substantially perpendicular to the surface of the base portion. In this specification, the term “substantially” means that a slight deviation from the perpendicular direction due to an error in leveling in a manufacturing process of the current collector, step variation in a manufacturing process of the protrusion portions, deformation due to repeated charge and discharge, and the like is acceptable although the angle between the surface of the base portion and a center axis of the protrusion portion in the longitudinal direction is preferably 90°. Specifically, the angle between the surface of the base portion and the center axis of the protrusion portion in the longitudinal direction is less than or equal to 90°±10°, preferably less than or equal to 90°±5°. Note that the direction in which the plurality of protrusion portions extends from the base portion is referred to as the longitudinal direction.

For the current collector, a conductive material which is not alloyed with carrier ions such as lithium ions is used. For example, a metal typified by stainless steel, tungsten, nickel, or titanium, an alloy of such a metal, or the like can be used.

Among the above described metals and alloys, titanium is particularly preferable for the current collector. Titanium has higher strength than steel, has mass which is less than or equal to half of that of steel, and is very light. In addition, titanium has strength about twice as high as that of aluminum and is less likely to have metal fatigue than other metals. For these reasons, titanium enables formation of a light battery and can function as a core of an active material layer, which has resistance to repeated stress; thus, deterioration or breakage due to expansion and contraction of silicon can be suppressed. Moreover, titanium is very suitable to be processed by dry etching and enables a protrusion portion having a high aspect ratio to be formed on a surface of the current collector.

The active material layer is provided to cover the base portion and the protrusion portions of such a current collector. The active material layer covers the protrusion portions of the current collector to form the negative electrode protrusion portions. On the other hand, the active material layer covers the base portion of the current collector with a substantially flat surface to form the negative electrode base portion. With a negative electrode including the negative electrode protrusion portions and the negative electrode base portion, a secondary battery can have discharge capacity higher than that of a secondary battery which includes a negative electrode including only a negative electrode base portion. For the active material layer, an active material including amorphous silicon, microcrystalline silicon, polycrystalline silicon, or a combination thereof can be used. An impurity imparting conductivity such as phosphorus or boron may be added to such silicon. Other than silicon, a substance having higher theoretical capacity than black lead, such as tin, can be used as the negative electrode active material as appropriate.

In the case of using silicon as the active material, the active material layer is formed by a low pressure chemical vapor deposition method (hereinafter also referred to as a low pressure CVD method or an LPCVD method) using a deposition gas containing silicon as a source gas. The LPCVD method is performed at a temperature higher than 500° C. in such a manner that a source gas including a deposition gas containing silicon is supplied into a reaction space. Thus, the active material layer is formed over the current collector.

As described above, since the current collector includes the plurality of protrusion portions extending substantially perpendicularly, the density of the protrusions can be increased in the negative electrode and thus the surface area can be increased. The plurality of protrusion portions has translation symmetry and is formed with high uniformity in the negative electrode; therefore, local reaction can be reduced in each of a positive electrode and the negative electrode, and carrier ions and the active material react with each other uniformly between the positive electrode and the negative electrode. Thus, with the negative electrode protrusion portions formed by covering the current collector with the active material layer including silicon or the like having a high theoretical capacity, a secondary battery can have high charge and discharge capacity.

However, even in the case where the negative electrode protrusion portions including tough cores are formed as described above, as charge and discharge cycles are repeated, the active material layer is separated in some cases depending on conditions such as the material, thickness, and shape of the current collector and the amount of occluded carrier ions in the active material. Separation of the active material layer reduces the discharge capacity of the secondary battery.

The active material layer mainly separates over the base portion of the current collector. This is attributed to the concentration of stress due to expansion and contraction of the active material to the negative electrode base portion. It is probable that because of the concentration of the stress, a crack is generated in part of the active material layer over the base portion of the current collector, and the separation takes place from the part where the crack is generated.

To prevent such deterioration around the active material layer which is over the base portion of the current collector, a high molecular material layer is provided on part of the side surfaces of the negative electrode protrusion portions including the basal portions thereof and the top surface of the negative electrode base portion. In other words, part of the negative electrode protrusion portions around the top portions thereof is exposed to an electrolyte solution so that capacity is formed by insertion and extraction of lithium ions, whereas a large part of the negative electrode protrusion portions is embedded in the high molecular material layer to be isolated from the electrolyte solution. The high molecular material layer does not react with carrier ions such as lithium ions and the carrier ions hardly pass through the high molecular material layer. Thus, the high molecular material layer serving as a barrier is provided to prevent occlusion of carrier ions to the active material layer of the negative electrode base portion or part of the active material layer which is over the basal portions of the negative electrode protrusion portions. Consequently, it is possible to reduce a change in the volume of the active material layer due to expansion and contraction thereof and to improve the reliability by suppressing the cycle deterioration of the negative electrode.

When the high molecular material layer is provided, two-quarters or more and less than four-quarter the height of the negative electrode protrusion portions is preferably covered with the high molecular material layer. The height of the negative electrode protrusion portions here means the length of a perpendicular line drawn from the top (or top surface) of the negative electrode protrusion portions to the surface of the negative electrode base portion in the cross-sectional shape in the longitudinal direction of the negative electrode protrusion portions. Note that in the case where the negative electrode base portion has a rough surface, the average height of the roughness is used as a reference. When the high molecular material layer with a thickness more than four-quarter the height of the negative electrode protrusion portions covers the negative electrode protrusion portions, that is, when the high molecular material layer with a thickness with which the negative electrode protrusion portions are completely embedded is formed, carrier ions cannot be occluded, which makes it difficult to form the discharge capacity of the secondary battery. On the other hand, when the high molecular material layer with a thickness less than two-quarters the height of the negative electrode protrusion portions covers the negative electrode protrusion portions, the active material layer of the negative electrode base portion occludes carrier ions and expands, which might cause the separation of the active material layer. In particular, three-quarters or more and less than four-quarter the height of the negative electrode protrusion portions is preferably covered with the high molecular material layer.

Because of being in contact with an electrolyte solution of a secondary battery, the high molecular material layer needs to be difficult to dissolve in the electrolyte solution. In addition, it is necessary that the high molecular material layer be not decomposed by reduction when the potential of the negative electrode is lowered. That is, for the high molecular material layer, it is possible to use high molecular materials which meet these conditions and are materials for a binder generally used for a negative electrode active material mixture layer. For example, the following materials can be used: styrene-butadiene rubber (SBR), polyvinyl alcohol (PVA), styrene-isoprene-styrene rubber, acrylonitrile-butadiene rubber, butadiene rubber, ethylene-propylene-diene copolymer, polyimide, polyvinyl chloride, polytetrafluoroethylene, polyethylene, polypropylene, isobutylene, polyethylene terephthalate, nylon, carboxylmethyl cellulose (CMC), polyvinylidene fluoride (PVDF), polyacrylonitrile (PAN), polyethylene oxide (PEO), polystyrene, polyacrylic acid methyl, polymethylmethacrylate (PMMA), and polypropylene oxide.

As described above, in the case where the negative electrode is used in a secondary battery, high-speed charge and discharge are possible, and breakage and separation of the active material due to charge and discharge can be suppressed. In other words, a secondary battery with further improved charge and discharge cycle characteristics and high reliability can be manufactured.

According to one embodiment of the present invention, a negative electrode for a secondary battery which has high charge and discharge capacity, can be charged and discharged at high speed, and has little deterioration due to charge and discharge, and a secondary battery using the negative electrode can be provided. The negative electrode for a secondary battery includes at least a current collector including a plurality of protrusion portions and an active material layer covering the protrusion portions.

According to one embodiment of the present invention, with the use of a material containing titanium having higher strength than metals such as aluminum and copper for a current collector including a plurality of protrusion portions, a highly reliable negative electrode for a secondary battery and a secondary battery using the negative electrode can be provided.

Further, according to one embodiment of the present invention, a high molecular material layer covers part of negative electrode protrusion portions including basal portions thereof and a negative electrode base portion; thus, insertion of carrier ions into an active material layer provided over the basal portions of the protrusion portions of a current collector and a base portion of the current collector can be suppressed, and expansion and contraction of part of the active material layer over the basal portion or the base portion can be suppressed, resulting in prevention of separation and peeling of the active material layer.

### BRIEF DESCRIPTION OF THE DRAWINGS

FIGS. 1A and 1B illustrate a negative electrode.

FIGS. 2A and 2B each illustrate a negative electrode.

FIGS. 3A to 3I each illustrate a shape of a protrusion portion of a negative electrode current collector.

FIGS. 4A to 4D each illustrate a negative electrode current collector.

FIGS. 5A to 5D illustrate a manufacturing method of a negative electrode.

FIGS. 6A to 6D illustrate a manufacturing method of a negative electrode.

FIGS. 7A to 7D illustrate a manufacturing method of a negative electrode.

FIGS. 8A to 8C illustrate a manufacturing method of a negative electrode.

FIGS. 9A to 9C illustrate a positive electrode.

FIGS. 10A and 10B illustrate a positive electrode.

FIGS. 11A and 11B each illustrate a separator-less secondary battery.

FIGS. 12A and 12B illustrate a coin-type secondary battery.

FIGS. 13A and 13B illustrate a cylindrical secondary battery.

FIG. 14 illustrates electrical appliances.

FIGS. 15A to 15C illustrate an electrical appliance.

FIGS. 16A and 16B illustrate an electrical appliance.

FIGS. 17A to 17C are SEM images of a negative electrode before being charged and discharged.

FIGS. 18A to 18C are SEM images of a negative electrode before being charged and discharged.

FIG. 19 is a SEM image of a negative electrode before being charged and discharged.

FIG. 20 is a graph showing variations in capacity with the number of cycles.

FIGS. 21A to 21C are SEM images of a negative electrode after being charged and discharged.

FIG. 22 is a SEM image of a negative electrode after being charged and discharged.

### DETAILED DESCRIPTION OF THE INVENTION

Embodiments are described below with reference to drawings. However, the embodiments can be implemented with various modes. It will be readily appreciated by those skilled in the art that modes and details can be changed in various ways without departing from the spirit and scope of the present invention. Thus, the present invention should not be interpreted as being limited to the following description of the embodiments.

### Embodiment 1

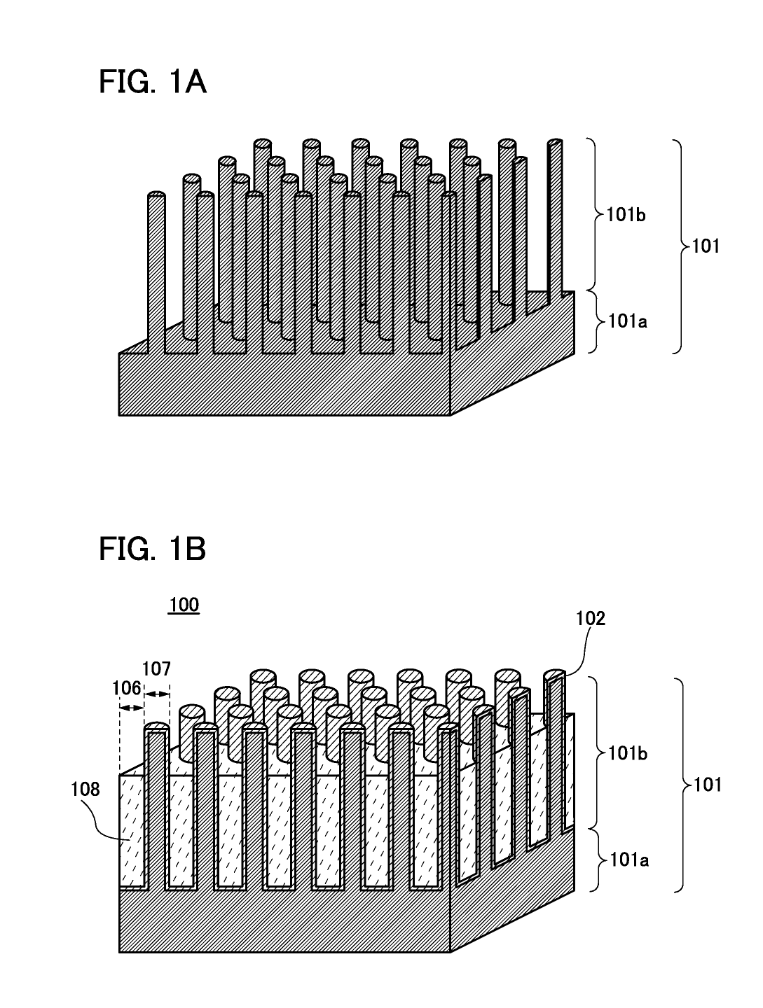

In this embodiment, a structure of a negative electrode for a secondary battery, which is less likely to deteriorate due to charge and discharge and has good charge and discharge cycle characteristics, and manufacturing methods of the negative electrode are described with reference to FIGS. 1A and 1B, FIGS. 2A and 2B, FIGS. 3A to 3I, FIGS. 4A to 4D, FIGS. 5A to 5D, FIGS. 6A to 6D, FIGS. 7A to 7D, and FIGS. 8A to 8C.

The secondary battery is a secondary battery in which a electrolyte solution is used and carrier ions are used for charge-discharge reaction. In particular, a secondary battery in which lithium ions are used as carrier ions is referred to as a lithium secondary battery. Examples of carrier ions which can be used instead of lithium ions include alkali-metal ions such as sodium ions and potassium ions; alkaline-earth metal ions such as calcium ions, strontium ions, and barium ions; beryllium ions; magnesium ions; and the like.

### (Structure of Negative Electrode)

FIG. 1A is a schematic cross-sectional view of an enlarged surface part of a negative electrode current collector. A negative electrode current collector 101 includes a plurality of protrusion portions 101b and a base portion 101a to which each of the plurality of protrusion portions is connected. Thus, the negative electrode current collector 101 has a structure like a spiky frog (kenzan) used in the Japanese art of flower arrangement. Although the thin base portion 101a is illustrated in the drawing, the base portion 101a is generally much thicker than the protrusion portions 101b.

The plurality of protrusion portions 101b extends in a direction substantially perpendicular to a surface of the base portion 101a. In this specification, the term “substantially” means that a slight deviation from the perpendicular direction due to an error in leveling in a manufacturing process of the negative electrode current collector, step variation in a manufacturing process of the protrusion portions 101b, deformation due to repeated charge and discharge, and the like is acceptable although the angle between the surface of the base portion 101a and a center axis of the protrusion portion 101b in the longitudinal direction is preferably 90°. Specifically, the angle between the surface of the base portion 101a and the center axis of the protrusion portion 101b in the longitudinal direction is less than or equal to 90°±10°, preferably less than or equal to 90°±5°. Note that the direction in which the plurality of protrusion portions 101b extends from the base portion 101a is referred to as the longitudinal direction.

The negative electrode current collector 101 is formed using a conductive material which is not alloyed with lithium in a potential region where the conductive material is used as a current collector and has high corrosion resistance. The negative electrode current collector 101 can be formed using, for example, a material having high conductivity, such as a metal typified by stainless steel, tungsten, nickel, or titanium, or an alloy thereof. Alternatively, the negative electrode current collector 101 may be formed using a metal element which forms silicide by reacting with silicon. Examples of the metal element which forms silicide by reacting with silicon include zirconium, titanium, hafnium, vanadium, niobium, tantalum, chromium, molybdenum, tungsten, cobalt, nickel, and the like.

It is particularly preferable to use titanium as the material for the negative electrode current collector 101. Titanium has higher strength than steel, has mass which is less than or equal to half of that of steel, and is very light. In addition, titanium has strength about twice as high as that of aluminum and is less likely to have metal fatigue than other metals. For these reasons, titanium enables formation of a light battery and can function as a core of a negative electrode active material, which has resistance to repeated stress; thus, deterioration or breakage due to expansion and contraction of silicon can be suppressed. Moreover, titanium is very suitable to be processed by dry etching and enables a protrusion portion with a high aspect ratio to be formed on a surface of the negative electrode current collector.

The negative electrode current collector 101 can have a foil-like shape, a plate-like shape (sheet-like shape), a net-like shape, a punching-metal shape, an expanded-metal shape, or the like as appropriate. In the case where a current collector material having a shape with an opening such as a net-like shape is used, a protrusion portion is formed on part of a surface of the current collector material where the opening is not provided, in the subsequent step.

FIG. 1B is a cross-sectional view of a negative electrode 100 in which a negative electrode active material layer 102 and a high molecular material layer 108 are formed over the negative electrode current collector 101.

The negative electrode active material layer 102 is provided to cover part of a top surface of the base portion 101a on which the protrusion portion 101b is not provided and side surfaces and top surfaces of the protrusion portions 101b, that is, an exposed surface of the negative electrode current collector 101. In this structure, a protrusion structure including the protrusion portion 101b of the negative electrode current collector and the negative electrode active material layer 102 provided on the top surface and the side surface of the protrusion portion 101b is referred to as a negative electrode protrusion portion 107 for convenience. Further, a portion where the negative electrode protrusion portion 107 is not formed, that is, a flat portion where a thin film of the negative electrode active material layer 102 is provided over the base portion 101a of the negative electrode current collector is referred to as a negative electrode base portion 106 for convenience.

Note that the term “active material” refers to a material that relates to occlusion (or insertion) and release (or extraction) of carrier ions and is distinguished from an active material layer.

As a negative electrode active material, an alloy-based material which enables charge-discharge reaction by alloying and dealloying reaction with a lithium metal can be used. For example, a material including at least one of Al, Si, Ge, Sn, Pb, Sb, Bi, Ag, Zn, Cd, In, Ga, and the like can be given. Such elements have higher capacity than carbon. In particular, silicon has a theoretical capacity of 4200 mAh/g, which is significantly high. For this reason, silicon is preferably used as the negative electrode active material. Examples of the alloy-based material using such elements include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, SbSn, and the like.

Alternatively, as the negative electrode active material, oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), molybdenum oxide (MoO₂), or the like can be used.

Further alternatively, as the negative electrode active material, Li₃₋ₓMₓN (M=Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g).

A nitride containing lithium and a transition metal is preferably used, in which case lithium ions are included in the negative electrode active material, and thus the negative electrode active material can be used in combination with a material for a positive electrode active material which does not include lithium ions, such as V₂O₅ or Cr₃O₈. Note that in the case of using a material including lithium ions as the positive electrode active material, the nitride containing lithium and a transition metal can be used for the negative electrode active material by extracting lithium ions in advance.

In the case where silicon is used for the negative electrode active material, amorphous silicon, microcrystalline silicon, polycrystalline silicon, or a combination thereof can be used. In general, when crystallinity is higher, electric conductivity of silicon is higher; thus, silicon can be used for a battery as an electrode having high conductivity. On the other hand, more carrier ions such as lithium ions can be occluded in the case of amorphous silicon than in the case of crystalline silicon; therefore, discharge capacity can be increased.

Alternatively, silicon to which an impurity element imparting one conductivity type, such as phosphorus or boron, is added may be used for the negative electrode active material layer 102. Silicon to which the impurity element imparting one conductivity type, such as phosphorus or boron, is added has higher conductivity, which results in an increase in the conductivity of the negative electrode.

The base portion 101a of the negative electrode current collector 101 functions as a terminal of a secondary battery and also as a base of the plurality of protrusion portions 101b. The base portion 101a and the plurality of protrusion portions 101b are formed using the same metal material and are physically continuous. For this reason, the protrusion portions 101b and the base portion 101a are combined to be strongly bonded to each other in connection portions therebetween; thus, even the connection portion where stress is particularly concentrated because of expansion and contraction of the negative electrode active material layer 102 provided over the base portion 101a and the protrusion portions 101b has strength high enough to withstand the stress. Therefore, the protrusion portion 101b can function as a core of the negative electrode protrusion portion 107.

The high molecular material layer 108 completely covers the negative electrode base portion 106 and a basal portion of the negative electrode protrusion portion 107. In other words, the negative electrode base portion 106 and the basal portion of the negative electrode protrusion portion 107 are embedded in the high molecular material layer 108. Consequently, the negative electrode active material layer 102 located on a surface of the negative electrode base portion 106 and part of the negative electrode active material layer 102 located on the side surface of the negative electrode protrusion portion 107 are in contact with the high molecular material layer 108. In such a manner, part of the negative electrode protrusion portion 107 around the top portion thereof is exposed to an electrolyte solution, whereas a large part of the negative electrode protrusion portion 107 is embedded in the high molecular material layer 108, so that part of the negative electrode active material layer 102 over the base portion 101a, which cause deterioration, is isolated from the electrolyte solution.

The high molecular material layer 108 does not react with carrier ions such as lithium ions and the carrier ions hardly pass through the high molecular material layer 108. Thus, the high molecular material layer 108 serving as a barrier is provided to prevent occlusion of carrier ions to the negative electrode active material layer 102 of the negative electrode base portion 106 or part of the negative electrode active material layer 102 which is over the basal portion of the negative electrode protrusion portion 107. Consequently, it is possible to reduce a change in the volume of the negative electrode active material layer due to expansion and contraction thereof and to improve the reliability by suppressing the cycle deterioration of the negative electrode 100.

When the high molecular material layer 108 is provided, two-quarters or more and less than four-quarter the height of the negative electrode protrusion portion 107 is preferably covered with the high molecular material layer 108. The height of the negative electrode protrusion portion here means the length of a perpendicular line drawn from the top (or top surface) of the negative electrode protrusion portion to the surface of the negative electrode base portion in the cross-sectional shape in the longitudinal direction of the negative electrode protrusion portion. Note that in the case where the negative electrode base portion 106 has a rough surface, the average height of the roughness is used as a reference. When the high molecular material layer 108 with a thickness more than four-quarter the height of the negative electrode protrusion portion 107 covers the negative electrode protrusion portion 107, that is, when the high molecular material layer 108 with a thickness with which the negative electrode protrusion portion 107 is completely embedded is formed, carrier ions cannot be occluded, which makes it difficult to form the discharge capacity of the secondary battery. On the other hand, when the high molecular material layer 108 with a thickness less than two-quarters the height of the negative electrode protrusion portion 107 covers the negative electrode protrusion portion 107, the negative electrode active material layer 102 of the negative electrode base portion 106 occludes carrier ions and expands, which might cause the separation of the negative electrode active material layer 102. In particular, three-quarters or more and less than four-quarter the height of the negative electrode protrusion portion 107 is preferably covered with the high molecular material layer 108.

Because of being in contact with the electrolyte solution of the secondary battery, the high molecular material layer 108 needs to be difficult to dissolve in the electrolyte solution. In addition, it is necessary that the high molecular material layer 108 be not decomposed by reduction when the potential of the negative electrode 100 is lowered. That is, for the high molecular material layer 108, it is possible to use high molecular materials which meet these conditions and are materials for a binder generally used for a negative electrode active material mixture layer. For example, a material such as styrene-butadiene rubber (SBR), polyvinyl alcohol (PVA), styrene-isoprene-styrene rubber, acrylonitrile-butadiene rubber, butadiene rubber, ethylene-propylene-diene copolymer, polyimide, polyvinyl chloride, polytetrafluoroethylene, polyethylene, polypropylene, isobutylene, polyethylene terephthalate, nylon, carboxylmethyl cellulose (CMC), polyvinylidene fluoride (PVDF), polyacrylonitrile (PAN), polyethylene oxide (PEO), polystyrene, polyacrylic acid methyl, polymethylmethacrylate (PMMA), or polypropylene oxide can be used.

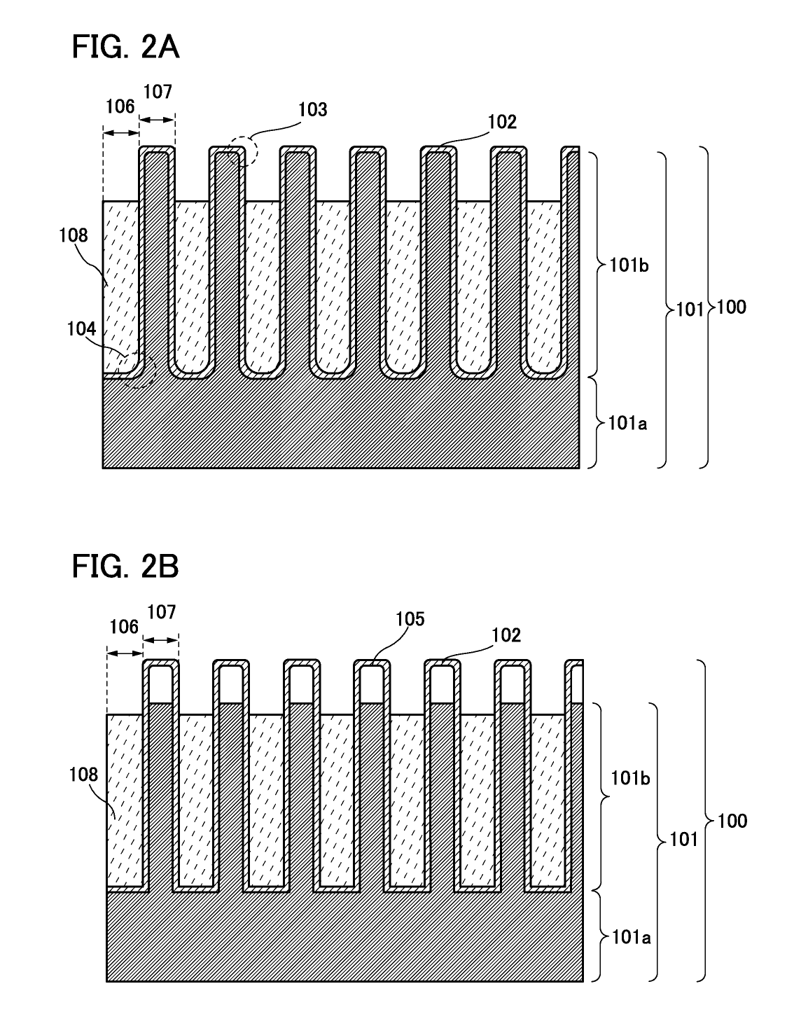

Next, a specific shape which is preferable for the protrusion portion 101b is described with reference to FIG. 2A. As illustrated in FIG. 2A, the protrusion portion 101b is preferably curved inward in the vicinity of the connection portion with the base portion 101a. A basal portion of the protrusion portion 101b is curved so that a surface of the base portion 101a and a side surface of the protrusion portion 101b (an edge portion 104 of the basal portion of the protrusion portion 101b) form a smooth curve without a corner, whereby stress is prevented from being concentrated on one point, and the protrusion portion 101b can have a strong structure. Further, the basal portion of the negative electrode protrusion portion 107 can be tightly covered with the high molecular material layer 108, which makes it possible to ensure prevention of occlusion of carrier ions to the negative electrode base portion 106. Thus, the separation of the negative electrode active material layer 102 from the negative electrode base portion 106 can be prevented.

Further, as illustrated in FIG. 2A, a boundary between the side surface and a top surface of the protrusion portion 101b (an edge portion 103 of the top surface of protrusion portion) is curved, whereby stress concentration on an edge portion can be reduced and mechanical strength against pressure applied from above the negative electrode can be obtained.

Further, spaces are provided between the plurality of protrusion portions; thus, contact between the negative electrode active material layers covering the protrusion portions can be reduced even when exposed parts of the negative electrode active material layers are expanded by insertion of lithium ions.

The plurality of protrusion portions has translation symmetry and is formed with high uniformity in the negative electrode 100; therefore, local reaction can be reduced in each of a positive electrode and the negative electrode, and reaction of carrier ions and an active material occurs uniformly between the positive electrode and the negative electrode. Thus, in the case where the negative electrode 100 is used for a secondary battery, high-speed charge and discharge are possible and breakage and separation of the active material due to charge and discharge can be suppressed, which makes it possible to manufacture a secondary battery with improved cycle characteristics.

Furthermore, shapes of the protrusion portions can be substantially the same, which enables local charge and discharge to be reduced and the weight of the active material to be controlled. In addition, with the protrusion portions having substantially the same height, load can be prevented from being applied locally in a manufacturing process of a battery, resulting in an increase in the yield. Accordingly, specifications of the battery can be well controlled.

Next, a structure of the negative electrode, which is different from the structure in FIG. 1B, is described with reference to FIG. 2B. The negative electrode illustrated in FIG. 2B differs from the negative electrode illustrated in FIG. 1B in that a protective layer 105 is provided on a tip of the protrusion portion of the negative electrode current collector 101.

The negative electrode current collector 101 is formed using a material and a structure which are similar to those of the negative electrode current collector of the negative electrode illustrated in FIG. 1B. In the negative electrode current collector, the protrusion portions 101b are provided over the base portion 101a. Moreover, in this negative electrode, the protective layer 105 is formed on a tip of the protrusion portion 101b, and the negative electrode active material layer 102 is provided to cover the negative electrode current collector 101 including the base portion 101a and the protrusion portions 101b and the protective layer 105.

The thickness of the protective layer 105 is preferably greater than or equal to 100 nm and less than or equal to 10 μm. The protective layer 105 serves as a hard mask in an etching step, and is thus preferably formed using a material which is highly resistant to etching with a gas used for etching the current collector material. For example, an insulator such as a silicon nitride film, a silicon oxide film, or a silicon oxynitride film can be used as a material for the protective layer 105.

With the use of such an insulator for the protective layer 105, higher etching selectivity than in the case of using a photoresist can be obtained.

In the case where a material which is alloyed with lithium is selected, the protective layer 105 can be used as part of the negative electrode active material layer, which contributes to an increase in capacity of a secondary battery. Further, in the case where a material with high electric conductivity is selected, the protective layer 105 can serve as part of the protrusion portion of the negative electrode current collector. However, a material which reacts with lithium ions to form irreversible capacity at the first charge of a secondary battery should not be selected for the protective layer 105.

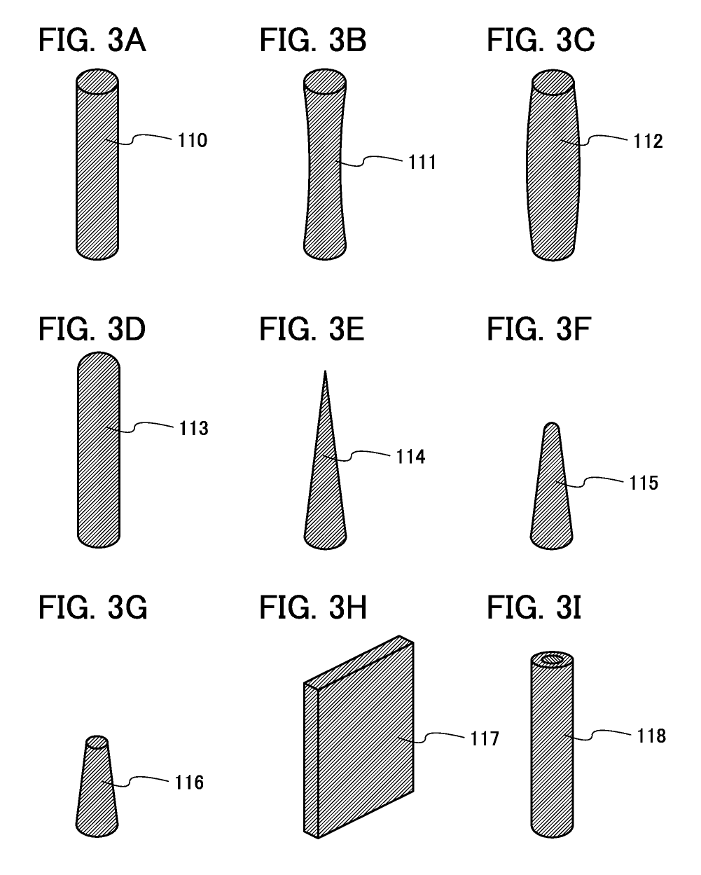

Shapes of the protrusion portion 101b described in this embodiment are described with reference to FIGS. 3A to 3I. A columnar protrusion 110 illustrated in FIG. 3A can be used as the protrusion portion 101b. The shape of a cross section which is parallel to the base portion is circular in the columnar protrusion 110; therefore, stress is applied isotropically from all directions, and thus a uniform negative electrode can be provided. FIGS. 3B and 3C similarly illustrate columnar protrusions: a protrusion 111 whose column is depressed inward and a protrusion 112 whose column expands outward. These shapes are more capable of controlling stress applied to the protrusions than the simple columnar protrusion illustrated in FIG. 3A; therefore, the mechanical strength can be increased by an appropriate structure design. A protrusion 113 illustrated in FIG. 3D has a structure in which a top surface of the columnar illustrated in FIG. 3A is curved. In the protrusion 113, stress applied to an edge portion of the top surface can be reduced more than in the columnar protrusion 110 illustrated in FIG. 3A, and coverage with a negative electrode active material over the protrusion 113 can be improved more than in the columnar protrusion 110 illustrated in FIG. 3A. FIG. 3E illustrates a conical protrusion 114. FIG. 3F illustrates a conical protrusion 115 which has a rounded end. FIG. 3G illustrates a conical protrusion 116 with a flat end. As in the protrusions 114, 115, and 116, the conical shape particularly enables the connection area with a base portion of a negative electrode current collector and resistance to stress to be increased. FIG. 3H illustrates a plate-like protrusion 117. FIG. 3I illustrates a pipe-like protrusion 118. In the pipe-like protrusion with a cavity inside, a negative electrode active material can be provided also in the cavity, resulting in an increase in the discharge capacity of the negative electrode.

It is preferable that the above-described protrusions are each curved inward in the vicinity of the connection portion with the base portion 101a as illustrated in FIG. 2A. A basal portion of the protrusion portion is curved so that a surface of the base portion 101a and the side surface of the protrusion portion 101b form a smooth curve without a corner; thus, stress is prevented from being concentrated on one point, and the protrusion portion 101b can have a strong structure.

The above-described shapes of the protrusion portion 101b are examples and the shape of the protrusion portion 101b described in this embodiment is not limited to the shapes of the protrusions 110 to 118. The protrusion portion 101b may have a combination of these shapes or a modified form of any of these shapes. A plurality of protrusions may be selected from the protrusions 110 to 118 as the plurality of protrusion portions 101b.

In particular, the protrusions 110, 111, 112, 116, 117, and 118 each have a flat surface at the end and can support a spacer described later with the flat surface in the case where the spacer is provided over the protrusions, and thus are suitable for a separator-less structure. Note that in FIG. 1A, the columnar protrusion 110 is used as the protrusion portion 101b.

In the protrusion with a flat end, the shape of the flat surface is not limited to circular shapes as in the protrusions 110, 111, 112, and 116, a plate-like shape as in the protrusion 117, and a pipe-like shape as in the protrusion 118, and may be any shape by which a flat surface can be formed, for example, a polygonal shape, an elliptical shape, or the like such as a C shape, an I shape, an L shape, an H shape, an S shape, a T shape, a U shape, or a V shape.

The negative electrode active material layer 102 can be formed on a top surface and a side surface of the protrusion portion 101b having any of the above-described shapes, and the basal portion of the negative electrode protrusion portion 107 including the protrusion portion 101b with any of the above-described shape can be covered with the high molecular material layer 108.

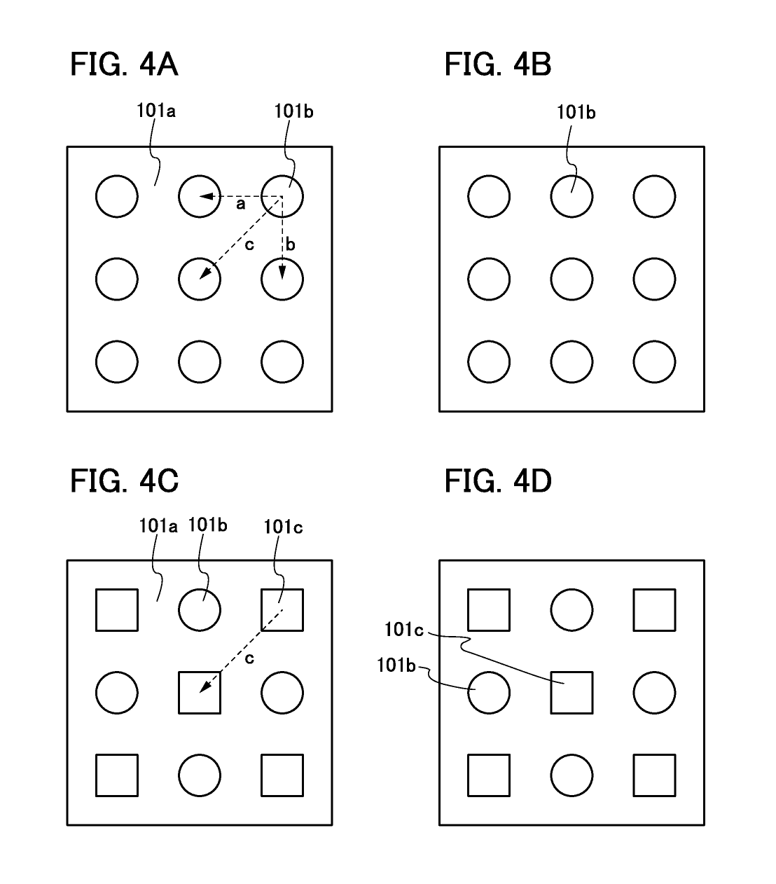

A shape of a top surface of the negative electrode current collector 101 described in this embodiment is described with reference to FIGS. 4A to 4D.

FIG. 4A is a top view illustrating the base portion 101a and the plurality of protrusion portions 101b protruding from the base portion 101a. The plurality of protrusion portions 101b with circular top surfaces is arranged. FIG. 4B is a top view after movement of FIG. 4A in the direction a. In FIGS. 4A and 4B, the plurality of protrusion portions 101b is located at the same positions. Here, the plurality of protrusion portions 101b in FIG. 4A moves in the direction a; however, the same result as FIG. 4B can be obtained after movement in the direction b or c. In other words, in a plane coordinates where the cross sections of the protrusions are arranged, the plurality of protrusion portions 101b illustrated in FIG. 4A has translation symmetry in which the positions of the protrusions are symmetric in translational operation.

FIG. 4C is a top view illustrating the base portion 101a and the plurality of protrusion portions 101b protruding from the base portion 101a. The protrusion portions 101b with circular top surfaces and protrusion portions 101c with square top surfaces are alternately arranged. FIG. 4D is a top view after movement of the protrusion portions 101b and 101c in the direction c. In the top views of FIGS. 4C and 4D, the protrusion portions 101b and 101c are located at the same positions. In other words, the plurality of protrusion portions 101b and 101c illustrated in FIG. 4C have translation symmetry.

By providing the plurality of protrusions such that they have translation symmetry, variation in electron conductivity among the plurality of protrusions can be reduced. Therefore, local reaction in the positive electrode and the negative electrode can be reduced, reaction between carrier ions and an active material can occur uniformly, diffusion overvoltage (concentration overvoltage) can be prevented, and thus the reliability of battery characteristics can be increased.

The width (diameter) of each of the plurality of protrusion portions 101b in the cross section is greater than or equal to 50 nm and less than or equal to 5 μm. The height of each of the plurality of protrusion portions 101b is greater than or equal to 1 μm and less than or equal to 100 μm. Thus, the aspect ratio of each of the plurality of protrusion portions 101b is greater than or equal to 0.2 and less than or equal to 2000.

The height of the protrusion portion 101b here means the length of a perpendicular line drawn from the top (or top surface) of the protrusion portion 101b to the surface of the base portion 101a in the cross-sectional shape in the longitudinal direction of the protrusion portion. Note that the boundary between the base portion 101a and the protrusion portion 101b is not always clear because the base portion 101a and the protrusion portion 101b are formed using the same current collector material, as is described later. For this reason, a plane in the negative electrode current collector, which is located on the same level as the top surface of the base portion 101a in a contact portion between the base portion 101a and the protrusion portion 101b of the negative electrode current collector is defined as the boundary between the base portion and the protrusion portion. Here, the boundary between the base portion and the protrusion portion is not included in the top surface of the base portion. In the case where the top surface of the base portion is rough, the top surface of the base portion is defined by the position obtained by average surface roughness.

The space between the adjacent protrusion portions 101b is preferably 3 times or more and less than 5 times as large as the thickness of the negative electrode active material layer 102 which is formed over the protrusion portion 101b. The reason for this is described below. When the space between the protrusion portions 101b is twice as large as the thickness of the negative electrode active material layer 102, the space is eliminated after the formation of the negative electrode active material layer 102; meanwhile, when the space is 5 times or more as large as the thickness of the negative electrode active material layer 102, the area of the negative electrode base portion 106 embedded in the high molecular material layer 108 is increased, which has little effect of increasing the surface area by the formation of the negative electrode protrusion portion 107.

As a result, even if the volume of the negative electrode active material layer 102 provided over the negative electrode protrusion portion 107 increases because of charging the secondary battery including the negative electrode 100, the protrusion portions are not in contact with each other and can be prevented from being broken, and a reduction in the charge and discharge capacity of the secondary battery can be prevented.

### (Manufacturing Method 1 of Negative Electrode)

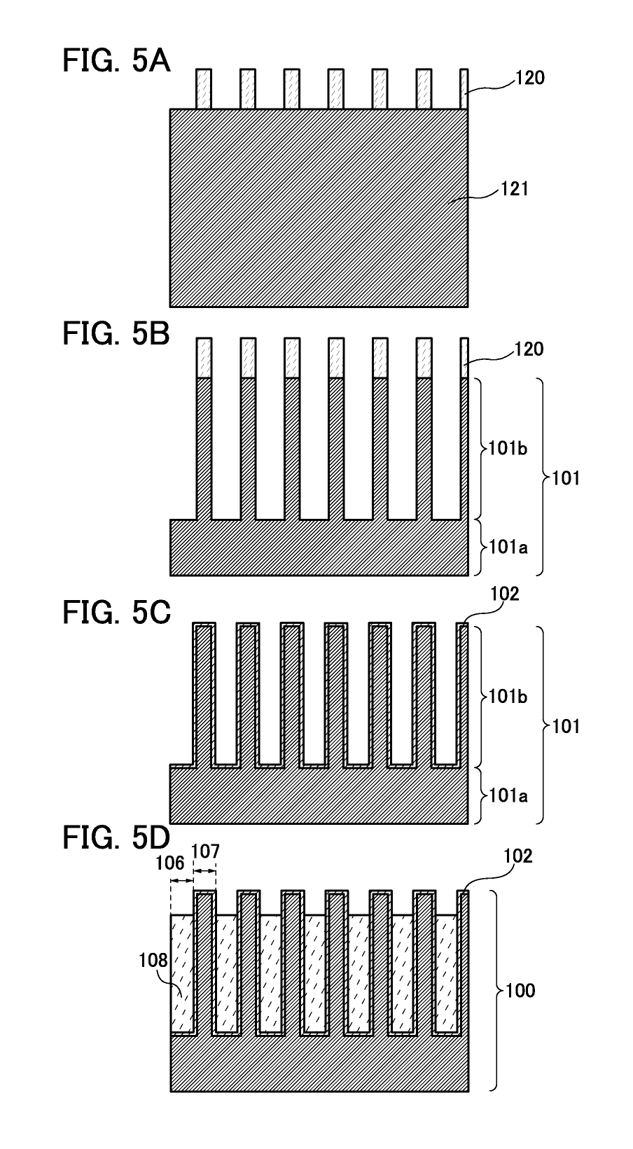

Next, a manufacturing method of the negative electrode 100 illustrated in FIG. 1B is described with reference to FIGS. 5A to 5D.

As illustrated in FIG. 5A, a photoresist pattern 120 which serves as a mask in an etching step is formed over a current collector material 121.

A conductive material which is not alloyed with lithium in a potential region where the conductive material is used as the current collector and has high corrosion resistance is used for the current collector material 121. For example, a material having high conductivity, such as a metal typified by stainless steel, tungsten, nickel, or titanium, or an alloy thereof can be used for the current collector material 121. Alternatively, a metal element which forms silicide by reacting with silicon may be used for the current collector material 121. Examples of the metal element which forms silicide by reacting with silicon include zirconium, titanium, hafnium, vanadium, niobium, tantalum, chromium, molybdenum, tungsten, cobalt, nickel, and the like.

It is particularly preferable to use titanium as the current collector material 121. Titanium has higher strength than steel, has mass which is less than or equal to half of that of steel, and is very light. In addition, titanium has strength about twice as high as that of aluminum and is less likely to have metal fatigue than other metals. Thus, titanium enables formation of a light battery and can function as a core of a negative electrode active material, which has resistance to repeated stress, so that deterioration or breakage due to expansion and contraction of silicon can be suppressed. Moreover, titanium is very suitable to be processed by dry etching and enables a protrusion portion with a high aspect ratio to be formed on a surface of the negative electrode current collector.

The current collector material 121 can have a foil-like shape, a plate-like shape (sheet-like shape), a net-like shape, a punching-metal shape, an expanded-metal shape, or the like as appropriate. In the case where a current collector material having a shape with an opening such as a net-like shape is used, a protrusion portion is formed on part of a surface of the current collector material where the opening is not provided, in the subsequent step.

The photoresist pattern 120 is exposed to light and developed in a photolithography step to be formed into a desired shape. The photoresist pattern 120 can be formed by an inkjet method, a printing method, or the like, instead of photolithography.

Next, the current collector material 121 is selectively etched using the photoresist pattern 120, whereby the negative electrode current collector 101 including the base portion 101a and the plurality of protrusion portions 101b is formed as illustrated in FIG. 5B. As a method for etching the current collector material, dry etching or wet etching can be used as appropriate. In particular, in the case where a protrusion portion with a high aspect ratio is formed, dry etching is preferably used.

For example, the current collector material 121 is etched using a mixed etching gas of BCl₃ and Cl₂ with an inductively coupled plasma (ICP) apparatus, whereby the negative electrode current collector 101 including the base portion 101a and the plurality of protrusion portions 101b can be formed. The flow ratio of the etching gas may be adjusted as appropriate. For example, the flow ratio of BCl₃ to Cl₂ can be set to 3:1. For dry etching, a parallel plate reactive ion etching (RIE) method can be employed.

The protrusion portion 101b can be formed into any shape by adjusting etching conditions such as an initial shape of the photoresist pattern, etching time, an etching gas, applied bias, pressure in a chamber, and substrate temperature as appropriate.

As described in this embodiment, the current collector material 121 is etched using the photoresist pattern 120 as a mask, whereby a plurality of protrusion portions extending substantially perpendicularly in the longitudinal direction can be formed. In addition, a plurality of protrusion portions which have substantially the same shape and are uniform can be formed.

After the protrusion portions 101b are formed, a remaining part of the current collector material 121 serves as the base portion 101a. The base portion 101a may have either a flat surface or a rough surface depending on an etching step. This is because in either case, the surface of the base portion 101a is covered with the high molecular material layer through the negative electrode active material layer and thus does not directly contribute to the characteristics of the secondary battery.

After the protrusion portions 101b are formed in the etching step, the photoresist pattern 120 used as a mask is removed in a photoresist separation step.

Next, the negative electrode active material layer is formed over the negative electrode current collector 101. It is preferable that the negative electrode active material layer 102 covers the exposed top surface of the negative electrode current collector as illustrated in FIG. 5C. In other words, the negative electrode active material layer 102 is formed so that the side surfaces and top surfaces of the protrusion portions 101b and the top surface of the base portion 101a where the protrusion portions 101b are not formed are covered with the negative electrode active material layer 102.

In the case where silicon is used for the negative electrode active material layer 102, the negative electrode active material layer 102 can be formed by a chemical vapor deposition (CVD) method typified by a plasma CVD method or a thermal CVD method, or a physical vapor deposition method typified by a sputtering method. Silicon can be single crystal silicon, polycrystalline silicon, amorphous silicon, or a combination thereof. The silicon layer may be formed using an n-type silicon layer to which phosphorus is added or a p-type silicon layer to which boron is added.

Next, the high molecular material layer 108 is formed to cover the negative electrode base portion 106 and the basal portion of the negative electrode protrusion portion 107. The high molecular material layer is formed by applying and drying a solution containing a high molecular material over the negative electrode active material layer 102. The high molecular material is applied as a solution, so that desired height of the negative electrode base portion 106 is filled with the high molecular material, depending on the amount of the dropping solution. Since the applied solution is dried in an environment such as a reduced pressure to form the high molecular material layer, the high molecular material layer 108 with a given thickness can be formed by controlling the amount of the dropping solution. Application and drying of the high molecular material may be repeated plural times to form a stack of the high molecular material layers 108. The high molecular material layer 108 preferably has a thickness two-quarters or more and less than four-quarter the height of the negative electrode protrusion portion 107. For example, in the case where the negative electrode protrusion portion 107 has a height of 3 μm, the high molecular material layer 108 may have a thickness of 1.5 μm or more and less than 3 μm.

A spin-coating method can also be used in the application step for forming the high molecular material layer. When the solution containing the high molecular material has high viscosity, the negative electrode protrusion portion 107 hinders the application and thus the high molecular material layer is not formed uniformly in some cases. For this reason, the negative electrode protrusion portion 107 can be arranged so that the solution containing the high molecular material is applied uniformly on a surface where the high molecular material layer is formed. Note that in the case where the solution containing the high molecular material has high viscosity, the flatness of the surface where the high molecular material layer is formed is preferably improved in advance.

### (Manufacturing Method 2 of Negative Electrode)

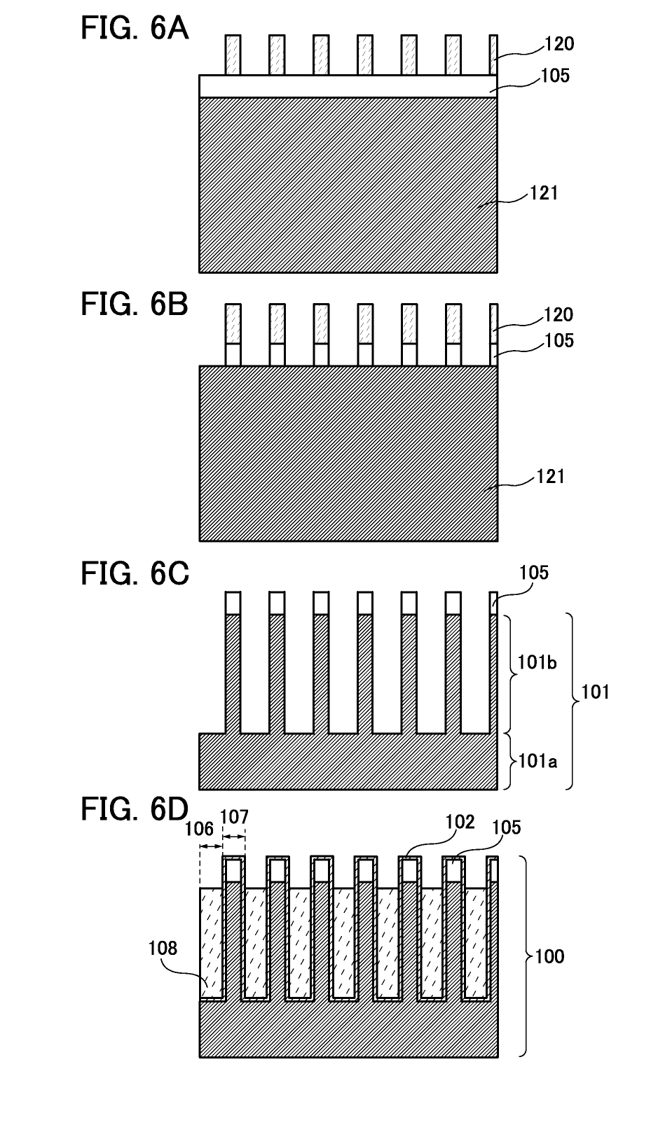

Next, a manufacturing method of the negative electrode 100 illustrated in FIG. 2B is described with reference to FIGS. 6A to 6D. This manufacturing method is different from Manufacturing Method 1 of Negative Electrode in that a protective layer is formed and used as a hard mask for etching.

First, the protective layer 105 is formed over the current collector material 121 which is the same as that in Manufacturing Method 1 of Negative Electrode (see FIG. 6A). The protective layer 105 can be formed by a CVD method, a sputtering method, an evaporation method, a plating method, or the like. The thickness of the protective layer 105 is preferably greater than or equal to 100 nm and less than or equal to 10 μm. The protective layer 105 serves as a hard mask in an etching step, and is thus preferably formed using a material which is highly resistant to etching with a gas used for etching the current collector material 121. For example, an insulator such as a silicon nitride film, a silicon oxide film, or a silicon oxynitride film can be used as a material for the protective layer 105. With the use of such an insulator for the protective layer 105, higher etching selectivity than in the case of using a photoresist can be obtained. In the case where a material which is alloyed with lithium is selected, the protective layer 105 can be used as part of the negative electrode active material, which contributes to an increase in capacity of a secondary battery. Further, in the case where a material with high electric conductivity is selected, the protective layer 105 can serve as part of the protrusion portion of the negative electrode current collector. However, a material which reacts with lithium ions to form irreversible capacity at the first charge of a secondary battery should not be selected for the protective layer 105.

Next, as illustrated in FIG. 6A, the photoresist pattern 120 is formed over the protective layer 105. Unlike in Manufacturing Method 1 of Negative Electrode, the photoresist pattern 120 is used to pattern the protective layer 105. The protective layer 105 is processed into a desired pattern using the photoresist pattern 120 as a mask (see FIG. 6B). As a dry etching method, a parallel plate reactive ion etching (RIE) method, an inductively coupled plasma (ICP) etching method, or the like can be used.

The photoresist pattern 120 is separated and removed with a chemical solution, and then the current collector material 121 is selectively etched using the protective layers 105 separated into individual patterns as masks as illustrated in FIG. 6C. Through this etching step, the base portion 101a and the protrusion portions 101b in the negative electrode current collector 101 are formed.

Next, as illustrated in FIG. 6D, the negative electrode active material layer 102 is formed to cover a surface of the base portion 101a, which is not provided with the protrusion portions, side surfaces of the protrusion portions 101b, and side surfaces and top surfaces of the protective layers 105. Then, the high molecular material layer 108 is formed so that the basal portion of the negative electrode protrusion portion 107 is covered. The negative electrode active material layer 102 can be formed in a manner similar to that described in Manufacturing Method 1 of Negative Electrode.

Through the above-described manufacturing method, the negative electrode 100 in which the protective layers 105 are directly formed on the protrusion portions 101b can be formed. Note that although the photoresist pattern 120 is removed at the time between the patterning of the protective layer 105 and the etching of the current collector material 121 in this manufacturing method, the photoresist pattern 120 may be removed after the current collector material 121 is etched.

In the case where the protrusion portions 101b are made tall, that is, etching time is long, if only the photoresist pattern is used as a mask, the thickness of the mask is gradually reduced to remove part of the mask, so that the surface of the current collector material 121 is exposed. This causes variation in height between the protrusion portions 101b. However, the use of the separated protective layers 105 as hard masks enables the current collector material 121 to be prevented from being exposed; thus, the variation in height between the protrusion portions 101b can be reduced.

When the protective layers 105 directly formed on the protrusion portions 101b are formed using a conductive material, the protective layers 105 can serve as part of the negative electrode current collector. In addition, when the protective layers 105 are formed using a material which is alloyed with lithium, the protective layers 105 can also serve as part of the negative electrode active material layer.

The protective layers 105 directly formed on the protrusion portions 101b contribute to an increase in the surface area of the negative electrode active material layer 102. In particular, in the case where the protrusion portions 101b are made tall, the etching time is long and there is a limitation on the height that can be formed. When the protective layers 105 are formed thick in view of the above, the protrusion portions on the base portion 101a can be long, which results in an increase in discharge capacity of a secondary battery. Thus, it is possible to compensate the capacity which is limited by covering the negative electrode active material layer 102 in the negative electrode base portion 106 with the high molecular material layer 108.

The ratio of the height of the protrusion portion 101b formed using the current collector material to the height (thickness) of the protective layer 105 can be adjusted as appropriate by controlling the thickness or the etching conditions. Various effects can be produced by freely adjusting the ratio in such a manner. For example, the shapes of the side surfaces of the protective layer 105 and the protrusion portion 101b are not necessarily the same because the protective layer 105 and the protrusion portion 101b are formed using different materials and processed in different etching steps. By using this fact, the shape of the protrusion portion 101b can be designed as appropriate. Further, depending on the position of a boundary between the protective layer 105 and the protrusion portion 101b, a protrusion structure with high mechanical strength can be formed.

### (Manufacturing Method 3 of Negative Electrode)

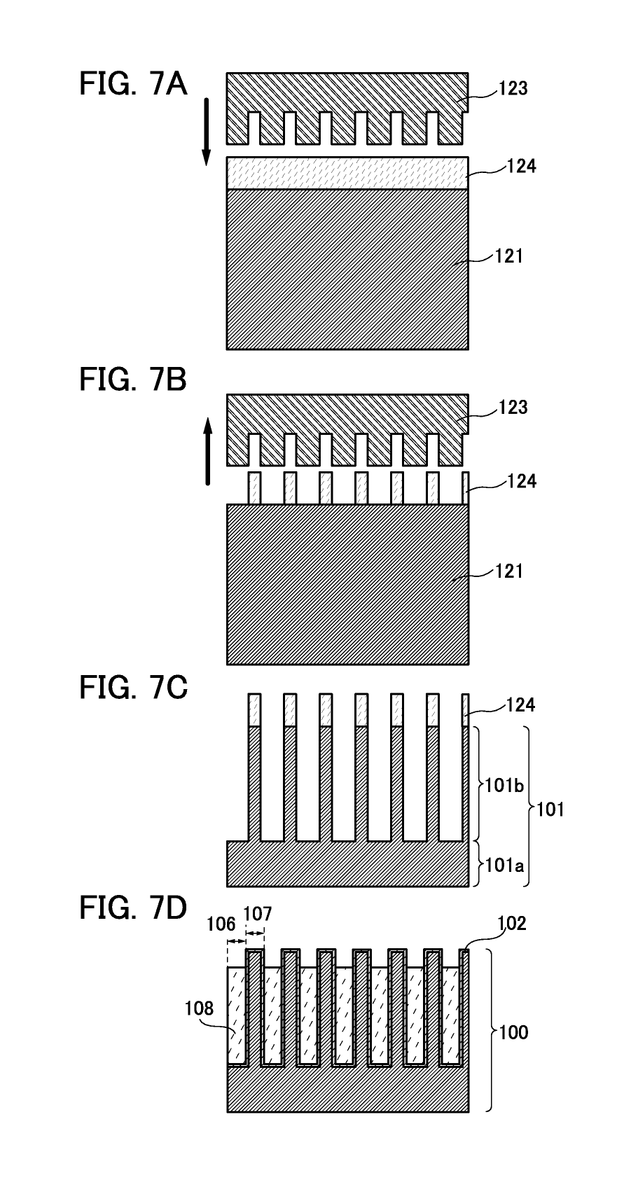

Although the negative electrode is manufactured by using photolithography for the formation of the photoresist pattern in Manufacturing Methods 1 and 2 of Negative Electrodes, the negative electrode 100 illustrated in FIG. 1B is manufactured by a different method in this manufacturing method. This manufacturing method is described with reference to FIGS. 7A to 7D. In this manufacturing method, the negative electrode current collector is manufactured by a nanoimprint method (hereinafter “nanoimprint lithography”).

The nanoimprint lithography is a microfabrication technology of a wiring that was proposed in 1995 by Stephen Y. Chou, a Professor of Princeton University, et al. The nanoimprint lithography has attracted attention owing to its capability of microfabrication to a resolution of about 10 nm at low cost without using a high-cost light exposure apparatus. There are thermal nanoimprint lithography and photo nanoimprint lithography in the nanoimprint lithography. A thermoplastic solid resin is used in the thermal nanoimprint lithography; a photocurable liquid resin is used in the photo nanoimprint lithography.

As illustrated in FIG. 7A, a resin 124 is applied over the current collector material 121 which is the same as that in Manufacturing Method 1 of Negative Electrode. As the resin 124, a thermoplastic resin is used in the case of the thermal nanoimprint lithography, while a photocurable resin which is cured by ultraviolet rays is used in the case of the photo nanoimprint lithography. As the thermoplastic resin, for example, polymethylmethacrylate (PMMA) can be used. A mold 123 is pressed against the resin 124 formed over the current collector material 121 to process the resin 124 into a desired pattern. The mold 123 used is obtained in the following manner: a resist is applied over a thermal silicon oxide film or the like, the resist is patterned by direct writing with an electron beam, and the thermal silicon oxide film is etched using the patterned resist as a mask.

In the case of the thermal nanoimprint lithography, a thermoplastic resin is heated to be softened before the mold 123 is pressed against the thermoplastic resin. Pressure is applied with the mold 123 in contact with the resin 124 to deform the resin 124 and cooling is performed with the pressure applied to cure the resin 124, whereby the concavity and convexity of the mold 123 are transferred to the resin 124 (see FIG. 7B).

In contrast, in the case of the photo nanoimprint lithography, the mold 123 is made in contact with the resin 124 to deform the resin 124, the resin 124 in this state is irradiated with ultraviolet rays to be cured, and then the mold is detached from the resin 124, whereby the concavity and convexity of the mold 123 can be transferred to the resin 124 (see FIG. 7B).

In either the thermal nanoimprint lithography or the photo nanoimprint lithography, since the mold 123 is pressed against the resin 124, the resin 124 remains under the mold 123 in some cases, and in such a case, a film remains at the bottom of a depressed portion of the resin 124 which has been modified and processed. For this reason, a surface of the resin 124 is subjected to anisotropic etching (RIE) with an oxygen gas to remove the remaining film. Through the above steps, the separated resins 124 which serve as masks in an etching step are formed.

Then, in a manner similar to that in Manufacturing Method 1 of Negative Electrode, the current collector material 121 is etched using the resins 124 as masks to form the plurality of protrusion portions 101b and the base portion 101a (see FIG. 7C). After the resins 124 are removed, the negative electrode active material layer 102 is formed to cover the negative electrode current collector 101 and then, the high molecular material layer 108 is formed to cover the negative electrode base portion 106 and the basal portion of the negative electrode protrusion portion 107 (see FIG. 7D).

Through the above steps, the negative electrode current collector 101 with a microstructure can be manufactured without using photolithography. In particular, in this manufacturing method, an expensive light exposure apparatus and an expensive photomask are not used; thus, the negative electrode 100 can be manufactured at low cost. In addition, a sheet-like material can be used as the current collector material 121 and a roll-to-roll method can be employed; therefore, this manufacturing method is suitable for mass production of negative electrodes.

### (Manufacturing Method 4 of Negative Electrode)

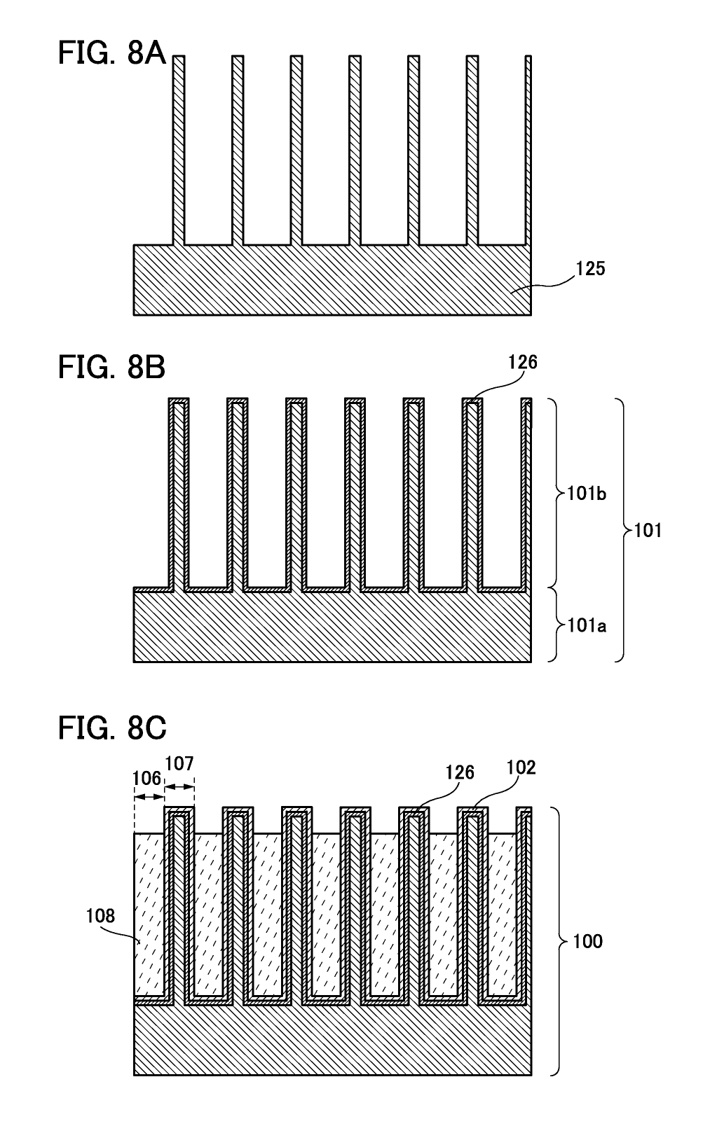

In this manufacturing method, the negative electrode 100 illustrated in FIG. 1B is manufactured by a method different from those in Manufacturing Methods 1 to 3 of Negative Electrodes. This manufacturing method is described with reference to FIGS. 8A to 8C. In this manufacturing method, protrusion portions are formed on a surface of a current collector material, and then the protrusion portions are covered with a conductive layer formed using a conductive material different from the current collector material; thus, a negative electrode current collector is manufactured.

First, as illustrated in FIG. 8A, protrusion portions are formed using a current collector material 125 by any of the methods described in Manufacturing Methods 1 to 3 of Negative Electrodes, and the like. Alternatively, the protrusion portions may be formed by pressing. The protrusion portions are covered with a conductive layer after this step, and thus need to have a diameter in view of the thickness of the conductive layer with which the protrusion portions are covered.

This manufacturing method is advantageous in that even a material which is difficult to function as a core of a negative electrode active material layer can be selected as the current collector material 125 because the protrusion portions are covered with the conductive layer. For example, copper or aluminum has high electric conductivity and is suitable for being processed. Thus, copper or aluminum allows the protrusion portions to be formed by pressing. However, copper or aluminum has high ductility and thus does not have structural strength high enough to function as a core of the negative electrode active material layer. Moreover, since a passivation film which is an insulator is formed on a surface of aluminum, electrode reaction does not occur even when the active material layer is made to be in direct contact with the aluminum surface. For this reason, a conductive layer 126 is separately formed over the current collector material, and thus the above problems can be solved.

Further, even if a material which can function as a core of a negative electrode active material layer is used as the current collector material 125, by covering the protrusion portions with a conductive layer formed using a hard material, mechanical strength can be further increased.

As illustrated in FIG. 8B, the conductive layer 126 is formed to cover the surface of the current collector material where the protrusion portions are formed. In this manner, the negative electrode current collector 101 including the base portion 101a and the protrusion portions 101b is formed.

A conductive material which is not alloyed with lithium can be used for the conductive layer 126. For example, a metal typified by stainless steel, tungsten, nickel, or titanium, or an alloy thereof can be used.

The conductive layer 126 can be formed by a sputtering method, an evaporation method, a metal organic chemical vapor deposition (MOCVD) method, or the like.

Then, as illustrated in FIG. 8C, the negative electrode active material layer 102 and the high molecular material layer 108 are formed over the conductive layer 126 by any of the methods given above. Through the above steps, the negative electrode 100 is manufactured.

In this manufacturing method, for example, formation of the conductive layer formed of titanium by a sputtering method over the current collector material formed of copper enables the protrusion portions with high strength to be formed. Thus, the function of the negative electrode protrusion portion as the core against expansion and contraction of the negative electrode active material (silicon) due to insertion and extraction of lithium ions is strengthened as well as suppressing occlusion of lithium to the negative electrode base portion by the high molecular material layer, resulting in an improvement of the reliability of the negative electrode.

This embodiment can be implemented in combination with any of the other embodiments.

### Embodiment 2

In this embodiment, a structure and a manufacturing method of a secondary battery are described.

First, a positive electrode and a manufacturing method thereof are described.

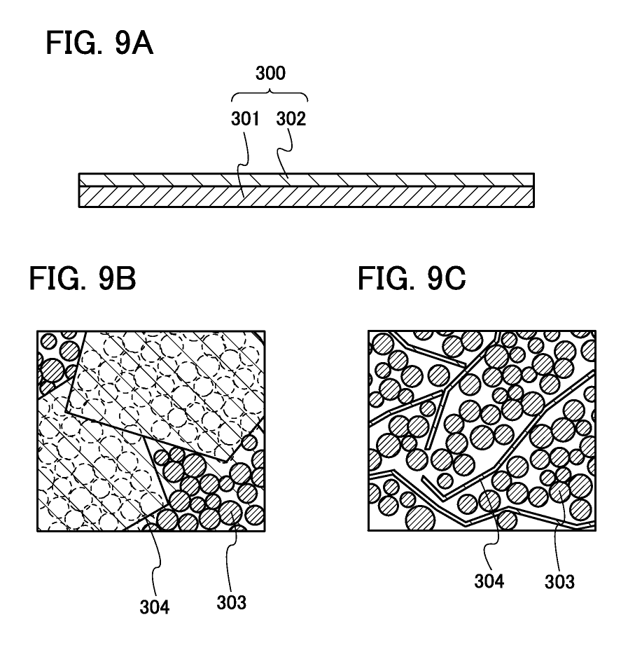

FIG. 9A is a cross-sectional view of a positive electrode 300. In the positive electrode 300, a positive electrode active material layer 302 is formed over a positive electrode current collector 301.

The positive electrode current collector 301 can be formed using a material having high conductivity such as stainless steel, gold, platinum, zinc, iron, copper, aluminum, or titanium, or an alloy thereof. Alternatively, the positive electrode current collector 301 can be formed using an aluminum alloy to which an element which improves heat resistance, such as silicon, titanium, neodymium, scandium, or molybdenum, is added. Further alternatively, the positive electrode current collector 301 may be formed using a metal element which forms silicide by reacting with silicon. Examples of the metal element which forms silicide by reacting with silicon include zirconium, titanium, hafnium, vanadium, niobium, tantalum, chromium, molybdenum, tungsten, cobalt, xnickel, and the like. The positive electrode current collector 301 can have a foil-like shape, a plate-like shape (sheet-like shape), a net-like shape, a punching-metal shape, an expanded-metal shape, or the like, as appropriate.

As a positive electrode active material used for the positive electrode active material layer, a material that can insert and extract lithium ions can be used. For example, a lithium-containing composite oxide with an olivine crystal structure, a layered rock-salt crystal structure, or a spinel crystal structure can be given.

As the lithium-containing composite oxide with an olivine crystal structure, a composite oxide represented by a general formula LiMPO₄ (M is one or more of Fe(II), Mn(II), Co(II), and Ni(II)) can be given. Typical examples of the general formula LiMPO₄ include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), LiFeⱼNi_{g}CoₕMnᵢPO₄ (f+g+h+i≦1, 0<f<1, 0<g<1, 0<h<1, and 0<i<1), and the like.

LiFePO₄ is particularly preferable because it meets requirements with balance for a positive electrode active material, such as safety, stability, high capacity density, high potential, and the existence of lithium ions that can be extracted in initial oxidation (charging).

Examples of the lithium-containing composite oxide with a layered rock-salt crystal structure include lithium cobalt oxide (LiCoO₂), LiNiO₂, LiMnO₂, Li₂MnO₃, an NiCo-based lithium-containing composite oxide (a general formula thereof is LiNiₓCo₁₋ₓO₂ (0<x<1)) such as LiNi_{0.8}Co_{0.2}O₂; an NiMn-based lithium-containing composite oxide (a general formula thereof is LiNiₓMn₁₋ₓO₂ (0<x<1)) such as LiNi_{0.5}Mn_{0.5}O₂; and an NiMnCo-based lithium-containing composite oxide (also referred to as NMC, and a general formula thereof is LiNiₓMn_{y}Co_{1-x-y}O₂ (x>0, y>0, x+y<1)) such as LiNi_{1/3}Mn_{1/3}Co_{1/3}O₂. Moreover, Li(Ni_{0.8}CO_{0.15}Al_{0.05})O₂, Li₂MnO₃—LiMO₂ (M=Co, Ni, or Mn), and the like can be given.

LiCoO₂ is particularly preferable because it has high capacity, is more stable in the air than LiNiO₂, and is more thermally stable than LiNiO₂, for example.

Examples of the lithium-containing composite oxide with a spinel crystal structure include LiMn₂O₄, Li₁₊ₓMn₂₋ₓO₄, Li(MnAl)₂O₄, LiMn_{1.5}Ni_{0.5}O₄, and the like.

A lithium-containing composite oxide with a spinel crystal structure including manganese, such as LiMn₂O₄, is preferably mixed with a small amount of lithium nickel oxide (e.g., LiNiO₂ or LiNi₁₋ₓMO₂ (M=Co, Al, or the like)), in which case elution of manganese and decomposition of an electrolyte solution are suppressed, for example.

As the positive electrode active material, a composite oxide represented by a general formula Li(₂₋ⱼ)MSiO₄ (M is one or more of Fe(II), Mn(II), Co(II), and Ni(II); 0≦j≦2) can be used. Typical examples of the general formula Li(₂₋ⱼ)MSiO₄ include Li(₂₋ⱼ)FeSiO₄, Li(₂₋ⱼ)NiSiO₄, Li(₂₋ⱼ)CoSiO₄, Li(₂₋ⱼ)MnSiO₄, Li(₂₋ⱼ)FeₖNiₗ/SiO₄, Li(₂₋ⱼ)FeₖCoₗSiO₄, Li(₂₋ⱼ)FeₖMnₗSiO₄, Li(₂₋ⱼ)NiₖCoₗSiO₄, Li(₂₋ⱼ)NiₖMnₗSiO₄ (k+1<1, 0<k<1, and 0<l<1), Li(₂₋ⱼ)FeₘNiₙCo_{g}SiO₄, Li(_{2-J})FeₘNiₙMn_{g}SiO₄, Li(₂₋ⱼ)NiₘCoₙMn_{q}SiO₄ (m+n+q≦1, 0<m<1, 0<n<1, and 0<q<1), Li(₂₋ⱼ)FeᵣNiₛCoₜMnᵤSiO₄ (r+s+t+u≦1, 0<r<1, 0<s<1, 0<t<1, and 0<u<1), and the like.

Further, as the positive electrode active material, a nasicon compound represented by a general formula AₓM₂(XO₄)₃ (A=Li, Na, or Mg; M=Fe, Mn, Ti, V, Nb, or Al; and X═S, P, Mo, W, As, or Si) can be used. Examples of the nasicon compound include Fe₂(MnO₄)₃, Fe₂(SO₄)₃, Li₃Fe₂(PO₄)₃, and the like. Further alternatively, as the positive electrode active material, a compound represented by a general formula Li₂ MPO₄F, Li₂ MP₂O₇, or Li₅MO₄ (M=Fe or Mn); perovskite fluoride such as NaF₃ or FeF₃; metal chalcogenide such as TiS₂ or MoS₂ (sulfide, selenide, or telluride); a lithium-containing composite oxide with an inverse spinel crystal structure such as LiMVO₄; a vanadium oxide based material (e.g., V₂O₅, V₆O₁₃, and LiV₃O₈); a manganese oxide based material; an organic sulfur based material; or the like can be used.

In the case where carrier ions are alkali metal ions other than lithium ions, alkaline-earth metal ions, beryllium ions, or magnesium ions, the positive electrode active material layer 302 may contain, instead of lithium in the lithium compound and the lithium-containing composite oxide, an alkali metal (e.g., sodium or potassium), an alkaline-earth metal (e.g., calcium, strontium, or barium), beryllium, or magnesium.

The positive electrode active material layer 302 is not necessarily formed directly on the positive electrode current collector 301. Between the positive electrode current collector 301 and the positive electrode active material layer 302, any of the following functional layers may be formed using a conductive material such as metal: an adhesive layer for the purpose of improving adhesiveness between the positive electrode current collector 301 and the positive electrode active material layer 302, a planarization layer for reducing unevenness of the surface of the positive electrode current collector 301, a heat radiation layer for radiating heat, and a stress relaxation layer for reducing stress on the positive electrode current collector 301 or the positive electrode active material layer 302.

FIG. 9B is a top view of the positive electrode active material layer 302 including particulate positive electrode active materials 303 that can occlude and release carrier ions, and sheets of graphene 304 each covering and at least partly surrounding part of the positive electrode active materials 303. The different sheets of the graphene 304 cover surfaces of part of the positive electrode active materials 303. The positive electrode active materials 303 may be partly exposed.

Note that graphene in this specification includes single-layer graphene or multilayer graphene including two to hundred layers. Single-layer graphene refers to a sheet of one-atomic-thick layer of carbon molecules having 7 bonds.

Note that in this specification, graphene oxide refers to a compound formed by oxidation of the above graphene. Further, in the case where graphene is formed by reduction of graphene oxide, oxygen included in the graphene oxide is not entirely extracted and partly remains in the graphene. In the case where the graphene contains oxygen, the proportion of oxygen is higher than or equal to 2 atomic % and lower than or equal to 20 atomic %, preferably higher than or equal to 3 atomic % and lower than or equal to 15 atomic %.

In the case where graphene is multilayer graphene and the graphene is formed by reducing graphene oxide here, the interlayer distance of graphene is greater than or equal to 0.34 nm and less than or equal to 0.5 nm, preferably greater than or equal to 0.38 nm and less than or equal to 0.42 nm, more preferably greater than or equal to 0.39 nm and less than or equal to 0.41 nm. Graphite generally includes single-layer graphene with an interlayer distance of 0.34 nm. On the other hand, graphene used for the secondary battery of one embodiment of the present invention has longer interlayer distance than that of graphite; therefore, carrier ions can be easily transferred between layers of multilayer graphene.

The size of the particle of the positive electrode active material 303 is preferably greater than or equal to 20 nm and less than or equal to 100 nm. Note that the size of the particle of the positive electrode active material 303 is preferably smaller because electrons transfer in the positive electrode active materials 303.

Although sufficient characteristics can be obtained even when the surfaces of the positive electrode active materials 303 are not covered with a graphite layer, it is preferable to use the positive electrode active materials 303 covered with a graphite layer, in which case hopping of carrier ions occurs between the positive electrode active materials 303, so that current flows.

FIG. 9C is a cross-sectional view of part of the positive electrode active material layer 302 in FIG. 9B. The positive electrode active material layer 302 includes the positive electrode active materials 303 and the sheets of the graphene 304 each covering part of the positive electrode active materials 303. The sheets of the graphene 304 are observed to have linear shapes in the cross-sectional view. Part of the positive electrode active materials is at least partly surrounded with one sheet of the graphene or plural sheets of the graphene. That is, part of the positive electrode active materials exists within one sheet of the graphene or plural sheets of the graphene. Note that the sheet of the graphene has a bag-like shape, and part of the positive electrode active materials is at least partly surrounded with the bag-like portion in some cases. In addition, the positive electrode active materials are partly not covered with the sheets of the graphene and exposed in some cases.

The desired thickness of the positive electrode active material layer 302 is determined in the range of 20 μm to 100 μm. It is preferable to adjust the thickness of the positive electrode active material layer 302 as appropriate so that cracks and separation do not occur.

Note that the positive electrode active material layer 302 may contain a known conductive additive, for example, acetylene black particles having a volume 0.1 to 10 times as large as that of the graphene or carbon particles such as carbon nanofibers having a one-dimensional expansion.

As an example of the positive electrode active material, a material whose volume is expanded by occlusion of ions serving as carriers is given. When such a material is used, the positive electrode active material layer gets vulnerable and is partly collapsed by charge and discharge, resulting in lower reliability of a secondary battery. However, even when the volume of the positive electrode active material expands due to charge and discharge, the graphene partly covers the periphery of the positive electrode active material, which allows prevention of dispersion of the positive electrode active material and the breakage of the positive electrode active material layer. That is to say, the graphene has a function of maintaining the bond between the positive electrode active materials even when the volume of the positive electrode active materials fluctuates by charge and discharge.

The graphene 304 is in contact with the plurality of particulate positive electrode active materials and serves also as a conductive additive. Further, the graphene 304 has a function of holding the positive electrode active materials capable of occluding and releasing carrier ions. Thus, a binder does not have to be mixed into the positive electrode active material layer 302. Accordingly, the amount of the positive electrode active materials in the positive electrode active material layer can be increased, which allows an increase in discharge capacity of a secondary battery.

Next, a manufacturing method of the positive electrode active material layer 302 is described.

Slurry containing particulate positive electrode active materials and graphene oxide is formed. After the slurry is applied over the positive electrode current collector 301, heating is performed in a reduced atmosphere for reduction treatment so that the positive electrode active materials are baked and oxygen included in the graphene oxide is extracted to form openings in the graphene. Note that oxygen in the graphene oxide is not entirely extracted and partly remains in the graphene. Through the above process, the positive electrode active material layer 302 can be formed over the positive electrode current collector 301. Consequently, the positive electrode active material layer 302 has higher conductivity.

Graphene oxide contains oxygen and thus is negatively charged in a polar solvent. As a result of being negatively charged, graphene oxide is dispersed. Therefore, the positive electrode active materials contained in the slurry are not easily aggregated, so that the size of the particle of the positive electrode active material can be prevented from increasing due to baking. Thus, the transfer of electrons in the positive electrode active materials is facilitated, resulting in an increase in conductivity of the positive electrode active material layer.

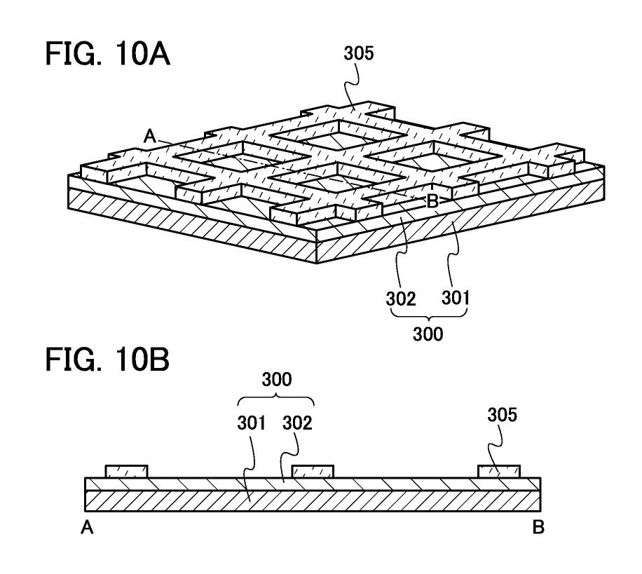

Now, an example in which a spacer 305 is provided on the surface of the positive electrode 300 is illustrated in FIGS. 10A and 10B. FIG. 10A is a perspective view of the positive electrode including the spacer, and FIG. 10B is a cross-sectional view taken along the dotted line A-B in FIG. 10A.

As illustrated in FIGS. 10A and 10B, in the positive electrode 300, the positive electrode active material layer 302 is provided over the positive electrode current collector 301. Further, the spacer 305 is provided over the positive electrode active material layer 302.

The spacer 305 can be formed using a material which has an insulating property and does not react with an electrolyte. Typically, an organic material such as an acrylic resin, an epoxy resin, a silicone resin, polyimide, or polyamide; or low-melting-point glass such as glass paste, glass frit, or glass ribbon can be used.

The spacer 305 can be formed by a printing method such as screen printing, an inkjet method, or the like. Thus, the spacer 305 can be formed in an arbitrary shape.

The spacer 305 is formed directly on the positive electrode active material layer 302 in a thin film form when seen from the above, and has a plurality of openings with a shape such as a rectangle, a polygon, or a circle. Thus, the planar shape of the spacer 305 can be a lattice-like shape, a closed circular or polygonal loop shape, porous shape, or the like. Alternatively, a plurality of the spacers may be arranged in a stripe by linearly extending the plurality of openings. The positive electrode active material layer 302 is partly exposed from the plurality of openings of the spacer 305. As a result, the spacer 305 prevents the positive electrode and a negative electrode from being in contact with each other and also ensures that carrier ions transfer between the positive electrode and the negative electrode through the plurality of openings.

The thickness of the spacer 305 is preferably greater than or equal to 1 μm and less than or equal to 5 μm, more preferably greater than or equal to 2 μm and less than or equal to 3 μm. As a result, as compared with the case where a separator having a thickness of several tens of micrometers is provided between a positive electrode and a negative electrode as in a conventional secondary battery, the distance between the positive electrode and the negative electrode can be reduced, and the distance of transfer of carrier ions between the positive electrode and the negative electrode can be made short. For this reason, carrier ions included in the secondary battery can be effectively used for charge and discharge.

As described above, it is not necessary to provide a separator in a secondary battery owing to the spacer 305. As a result, the number of components of the secondary battery and the cost can be reduced.

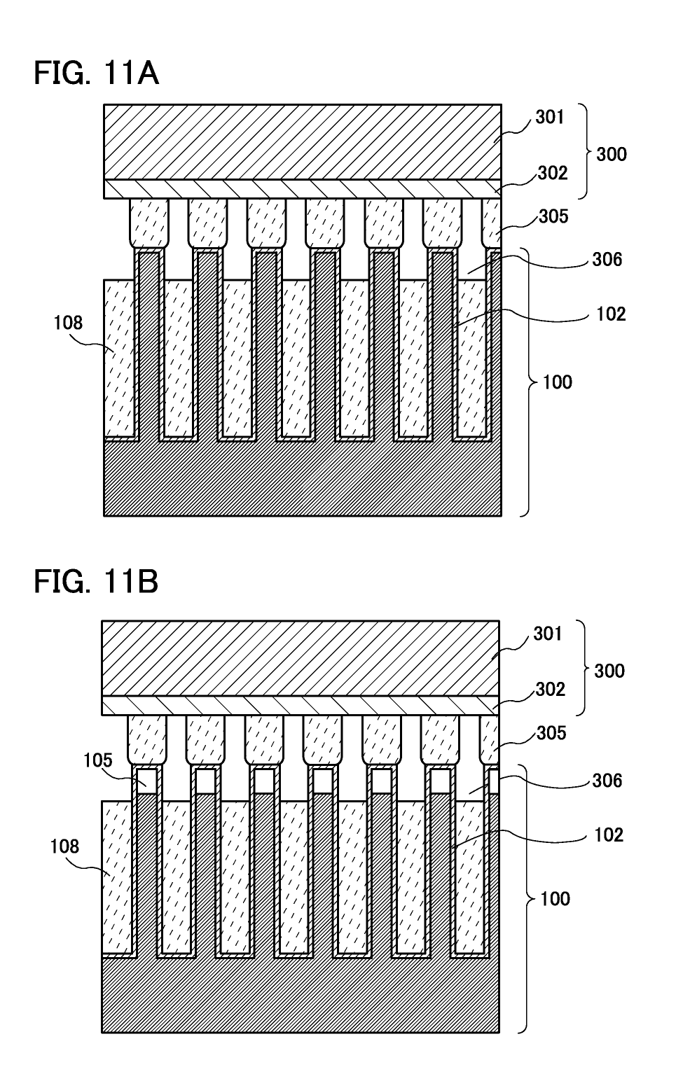

An example of a separator-less secondary battery using the spacer 305 is illustrated in FIGS. 11A and 11B. In FIG. 11A, a battery is assembled from the negative electrode 100 formed through the above manufacturing method of a negative electrode and the above positive electrode 300, between which the spacer 305 is interposed, and spaces made by the negative electrode 100, the positive electrode 300, and the spacer 305 are filled with an electrolyte 306. The shape of the protrusion portions of the negative electrode 100 or the spacer 305 is designed so that the protrusion portions thereof make contact with the spacer 305. The protrusion portions and the spacer preferably make surface contact with each other in order to maintain the mechanical strength. Thus, the surface of the spacer 305 and the surfaces of the protrusion portions of the negative electrode 100 which make contact with each other are preferably as flat as possible.

Therefore, as illustrated in FIGS. 11A and 11B, it is particularly preferable to use the negative electrode including the protective layer 105 above the protrusion portions, which is formed through Manufacturing Method 2 of Negative Electrode.

Note that although all protrusion portions and the spacer are in contact with each other in FIGS. 11A and 11B, all protrusion portions do not necessarily make contact with the spacer. That is, there is no problem even if some of the plurality of protrusion portions of the negative electrode is placed in a position facing the openings in the spacer 305.

Further, as well as the spacer 305, the protrusion portions of the negative electrode 100, which are in contact with the spacer 305, have a function of keeping a distance between the positive electrode 300 and the negative electrode 100. Thus, it is important that the protrusion portions have sufficient mechanical strength. Therefore, an extremely significant structure can be obtained when a current collector material which forms the protrusion portions is used as a core of the negative electrode active material layer formed over the protrusion portions, and titanium whose strength is higher than that of copper or the like is used.

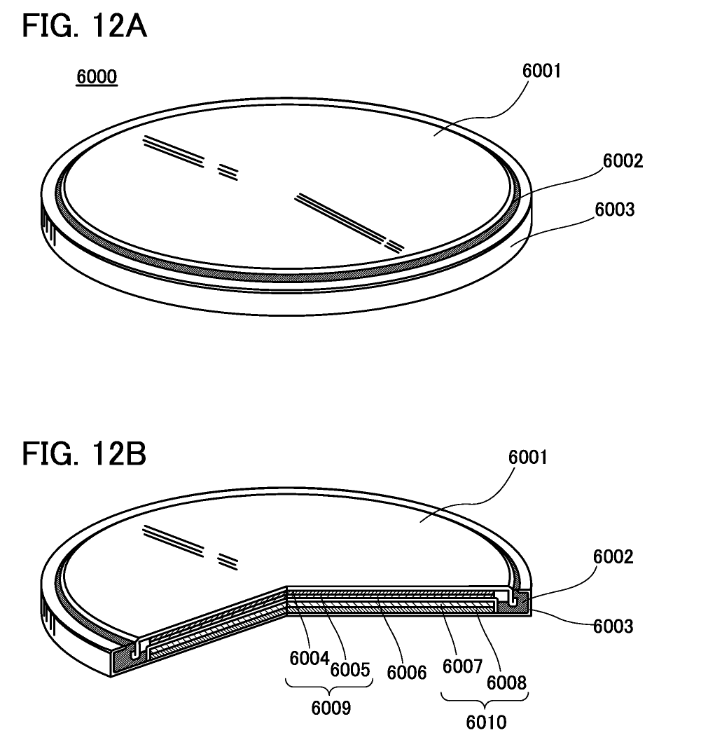

Next, a structure and a manufacturing method of the secondary battery are described with reference to FIGS. 12A and 12B. Here, a cross-sectional structure of the secondary battery is described below.

FIG. 12A is an external view of a coin-type (single-layer flat type) secondary battery, and FIG. 12B is a cross-sectional view thereof.

In a coin-type secondary battery 6000, a positive electrode can 6003 serving also as a positive electrode terminal and a negative electrode can 6001 serving also as a negative electrode terminal are insulated and sealed with a gasket 6002 formed of polypropylene or the like. In a manner similar to that of the above, a positive electrode 6010 includes a positive electrode current collector 6008 and a positive electrode active material layer 6007 which is provided to be in contact with the positive electrode current collector 6008. On the other hand, a negative electrode 6009 includes a negative electrode current collector 6004 and a negative electrode active material layer 6005 which is provided to be in contact with the negative electrode current collector 6004. A separator 6006 and an electrolyte (not illustrated) are included between the positive electrode active material layer 6007 and the negative electrode active material layer 6005. In the positive electrode 6010, a positive electrode active material layer which is obtained by the above process is used as the positive electrode active material layer 6007.

The negative electrode 100 described in Embodiment 1 can be used as appropriate as the negative electrode.

As the positive electrode current collector 6008 and the positive electrode active material layer 6007, the positive electrode current collector 301 and the positive electrode active material layer 302 which are described in this embodiment can be used as appropriate.

For the separator 6006, an insulator such as cellulose (paper), polypropylene with pores, or polyethylene with pores can be used.

Note that the separator 6006 is not necessarily provided when the above positive electrode including the spacer 305, which is illustrated in FIGS. 10A and 10B, is used as the positive electrode 6010.

As a solute of the electrolyte solution, a lithium salt including lithium that is a carrier ion is used. Typical examples of the lithium salt include LiClO₄, LiAsF₆, LiBF₄, LiPF₆, and Li(C₂F₅SO₂)₂N.

In the case where carrier ions are alkali metal ions other than lithium ions, alkaline-earth metal ions, beryllium ions, or magnesium ions, the solute of the electrolyte solution may contain, instead of lithium in the lithium salts, an alkali metal (e.g., sodium or potassium), an alkaline-earth metal (e.g., calcium, strontium, or barium), beryllium, or magnesium.

As a solvent for the electrolyte solution, a material in which carrier ions can transfer is used. For example, a non-aqueous electrolyte solution may be used. As the solvent for the electrolyte solution, an aprotic organic solvent is preferably used. Typical examples of aprotic organic solvents include ethylene carbonate (EC), propylene carbonate, dimethyl carbonate, diethyl carbonate (DEC), γ-butyrolactone, acetonitrile, dimethoxyethane, and tetrahydrofuran, and one or more of these materials can be used. When a gelled high-molecular material is used as the solvent for the electrolyte solution, safety against liquid leakage and the like is improved. Further, a secondary battery can be thinner and more lightweight. Typical examples of gelled high-molecular materials include a silicone gel, an acrylic gel, an acrylonitrile gel, polyethylene oxide, polypropylene oxide, a fluorine-based polymer, and the like. Alternatively, the use of one or more of ionic liquids (room temperature molten salts) which are less likely to burn and volatilize as the solvent for the electrolyte solution can prevent the secondary battery from exploding or catching fire even when the secondary battery internally shorts out or the internal temperature increases due to overcharging or the like.

Instead of the electrolyte solution, a solid electrolyte including a sulfide-based inorganic material, an oxide-based inorganic material, or the like, or a solid electrolyte including a polyethylene oxide (PEO)-based high-molecular material or the like can be used. In the case of using the solid electrolyte, a separator or a spacer is not necessary. Further, the battery can be entirely solidified; therefore, there is no possibility of liquid leakage and thus the safety of the battery is dramatically increased.

For the positive electrode can 6003 and the negative electrode can 6001, a corrosion-resistant metal such as nickel, aluminum, or titanium, an alloy of such a metal, or an alloy of such a metal and another metal (e.g., stainless steel or the like) can be used. It is particularly preferable to plate a corrosive metal with nickel or the like in order to prevent corrosion by the electrolyte solution, which occurs due to charge and discharge of the secondary battery. The positive electrode can 6003 and the negative electrode can 6001 are electrically connected to the positive electrode 6010 and the negative electrode 6009, respectively.

The negative electrode 6009, the positive electrode 6010, and the separator 6006 are immersed in the electrolyte solution. Then, as illustrated in FIG. 12B, the positive electrode 6010, the separator 6006, the negative electrode 6009, and the negative electrode can 6001 are stacked in this order with the positive electrode can 6003 positioned at the bottom, and the positive electrode can 6003 and the negative electrode can 6001 are subjected to pressure bonding with the gasket 6002 interposed therebetween. In such a manner, the coin-type secondary battery 6000 is manufactured.

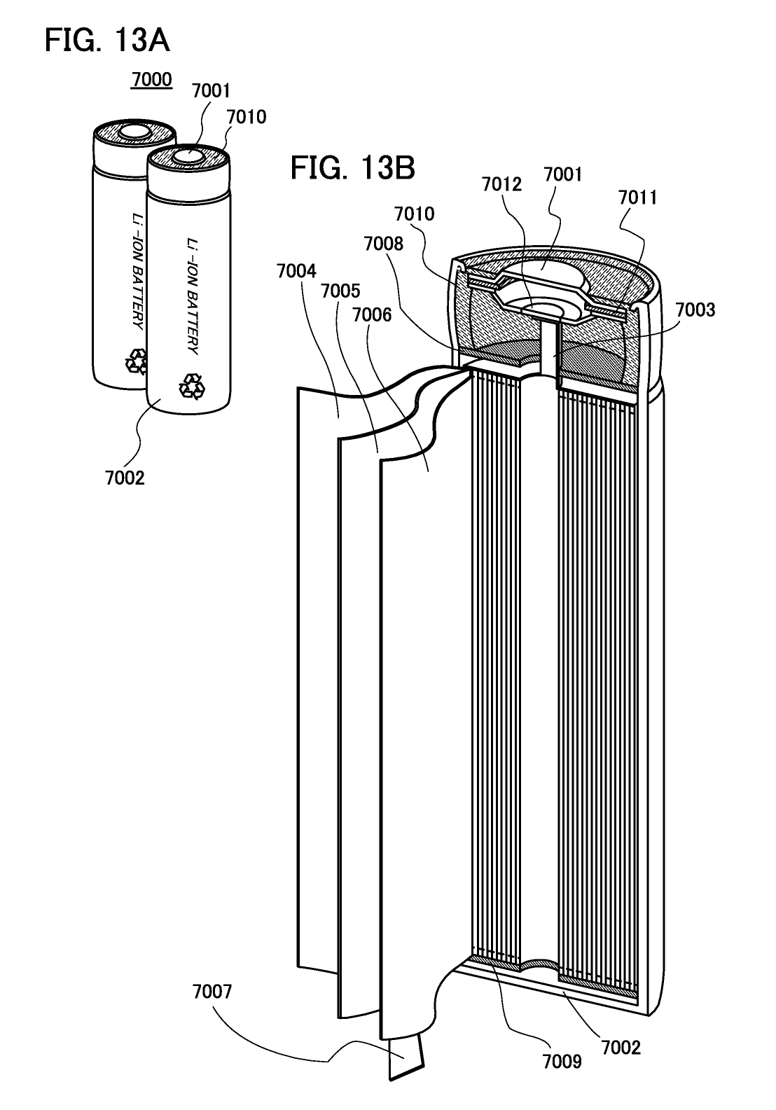

A structure of a cylindrical secondary battery is described with reference to FIGS. 13A and 13B. As illustrated in FIG. 13A, a cylindrical secondary battery 7000 includes a positive electrode cap (battery cap) 7001 on the top surface and a battery can (outer can) 7002 on the side surface and bottom surface. The positive electrode cap 7001 and the battery can 7002 are insulated from each other by a gasket 7010 (insulating packing).

FIG. 13B is a diagram schematically illustrating a cross section of the cylindrical secondary battery. In the battery can 7002 with a hollow cylindrical shape, a battery element is provided in which a strip-like positive electrode 7004 and a strip-like negative electrode 7006 are wound with a separator 7005 provided therebetween. Although not illustrated, the battery element is wound around a center pin as a center. One end of the battery can 7002 is close and the other end thereof is open. For the battery can 7002, a corrosion-resistant metal such as nickel, aluminum, or titanium an alloy of such a metal, or an alloy of such a metal and another metal (e.g., stainless steel or the like) can be used. It is particularly preferable to plate a corrosive metal with nickel or the like in order to prevent corrosion by the electrolyte solution, which occurs due to charge and discharge of the secondary battery. Inside the battery can 7002, the battery element in which the positive electrode, the negative electrode, and the separator are wound is interposed between a pair of insulating plates 7008 and 7009 which face each other. Further, an electrolyte solution (not illustrated) is injected inside the battery can 7002 in which the battery element is provided. An electrolyte solution which is similar to that of the coin-type secondary battery can be used.

Although the positive electrode 7004 and the negative electrode 7006 can be formed in a manner similar to that of the positive electrode and the negative electrode of the coin-type secondary battery 6000, the difference lies in that, since the positive electrode and the negative electrode of the cylindrical secondary battery are wound, active materials are formed on both sides of the current collectors. The use of the negative electrode described in Embodiment 1 for the negative electrode 7006 enables the secondary battery with high capacity to be manufactured. A positive electrode terminal (positive electrode current collecting lead) 7003 is connected to the positive electrode 7004, and a negative electrode terminal (negative electrode current collecting lead) 7007 is connected to the negative electrode 7006. A metal material such as aluminum can be used for both the positive electrode terminal 7003 and the negative electrode terminal 7007. The positive electrode terminal 7003 is resistance-welded to a safety valve mechanism 7012, and the negative electrode terminal 7007 is resistance-welded to the bottom of the battery can 7002. The safety valve mechanism 7012 is electrically connected to the positive electrode cap 7001 through a positive temperature coefficient (PTC) element 7011. The safety valve mechanism 7012 cuts off electrical connection between the positive electrode cap 7001 and the positive electrode 7004 when the internal pressure of the battery increases and exceeds a predetermined threshold value. The PTC element 7011 is a heat sensitive resistor whose resistance increases as temperature rises, and controls the amount of current by increase in resistance to prevent unusual heat generation. Barium titanate (BaTiO₃)-based semiconductor ceramic or the like can be used for the PTC element.

Note that in this embodiment, the coin-type secondary battery and the cylindrical secondary battery are given as examples of the secondary battery; however, any of secondary batteries with various shapes, such as a sealing-type secondary battery and a square-type secondary battery, can be used. Further, a structure in which a plurality of positive electrodes, a plurality of negative electrodes, and a plurality of separators are stacked or wound may be employed.

This embodiment can be implemented combining with any of the other embodiments as appropriate.

### Embodiment 3

A secondary battery of one embodiment of the present invention can be used for power sources of a variety of electrical appliances which can operate by power.

Specific examples of electrical appliances using the secondary battery of one embodiment of the present invention are as follows: display devices of televisions, monitors, and the like, lighting devices, desktop personal computers and laptop personal computers, word processors, image reproduction devices which reproduce still images and moving images stored in recording media such as digital versatile discs (DVDs), portable CD players, portable radios, tape recorders, headphone stereos, stereos, table clocks, wall clocks, cordless phone handsets, transceivers, portable wireless devices, cellular phones, car phones, portable game consoles, toy, calculators, portable information terminals, electronic notebooks, e-book readers, electronic translators, audio input devices, video cameras, digital still cameras, electric shavers, high-frequency heating appliances such as microwave ovens, electric rice cookers, electric washing machines, electric vacuum cleaners, water heaters, electric fans, hair dryers, air-conditioning systems such as air conditioners, humidifiers, and dehumidifiers, dishwashers, dish dryers, clothes dryers, futon dryers, electric refrigerators, electric freezers, electric refrigerator-freezers, freezers for preserving DNA, flashlights, electric power tools such as chain saws, smoke detectors, radiation counters, and medical equipment such as dialyzers. Further, in addition to industrial equipment such as guide lights, traffic lights, belt conveyors, elevators, escalators, industrial robots, and power storage systems, power storage devices for smart grid, which is a power grid performing decentralized autonomous control of power by a control device, can be given. In addition, moving objects driven by an electric motor using power from a secondary battery are also included in the category of the electrical appliances. Examples of the moving objects are electric vehicles (EV), hybrid electric vehicles (HEV) which include both an internal-combustion engine and a motor, plug-in hybrid electric vehicles (PHEV), tracked vehicles in which caterpillar tracks are substituted for wheels of these vehicles, motorized bicycles including motor-assisted bicycles, motorcycles, electric wheelchairs, golf carts, boats, ships, submarines, helicopters, aircrafts, rockets, artificial satellites, space probes, planetary probes, and spacecrafts.

In the above electrical appliances, the secondary battery of one embodiment of the present invention can be used as a main power source for supplying enough power for almost the whole power consumption. Alternatively, in the above electrical appliances, the secondary battery of one embodiment of the present invention can be used as an uninterruptible power source which can supply power to the electrical appliances when the supply of power from the main power source or a commercial power source is stopped. Still alternatively, in the above electrical appliances, the secondary battery of one embodiment of the present invention can be used as an auxiliary power source for supplying power to the electrical appliances at the same time as the power supply from the main power source or a commercial power source.

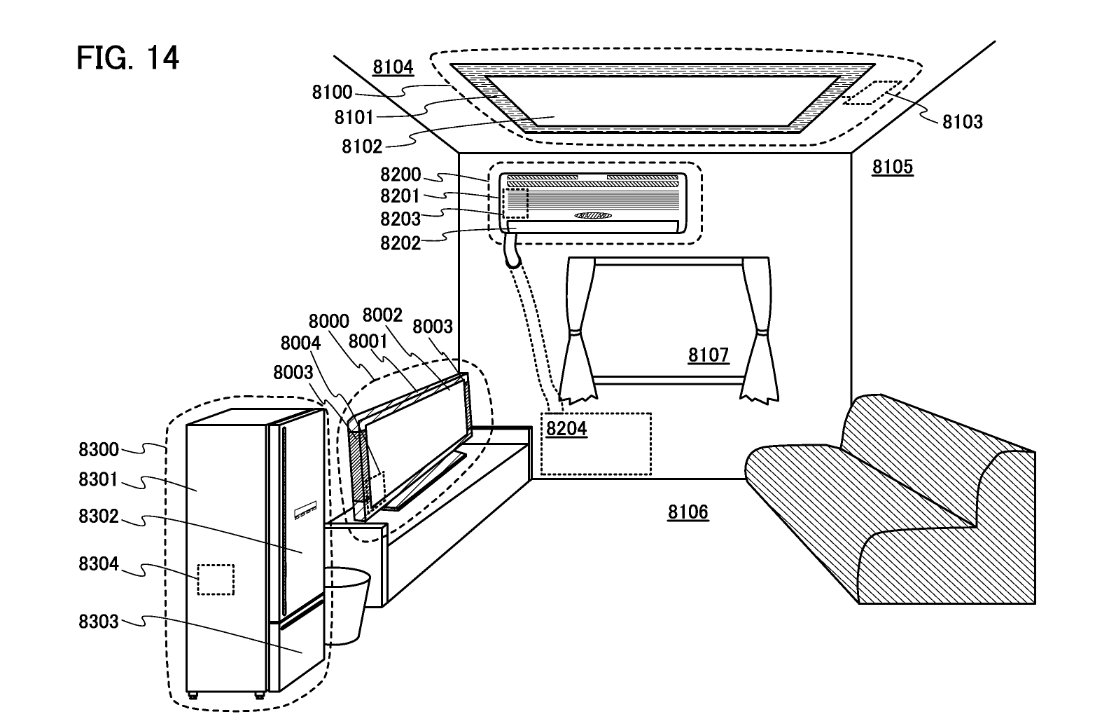

FIG. 14 illustrates specific structures of the electrical appliances. In FIG. 14, a display device 8000 is an example of an electrical appliance using a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can receive power from a commercial power source. Alternatively, the display device 8000 can use power stored in the secondary battery 8004. Thus, the display device 8000 can be operated with the use of the secondary battery 8004 of one embodiment of the present invention as an uninterruptible power source even when power cannot be supplied from a commercial power source due to power failure or the like.

A semiconductor display device such as a liquid crystal display device, a light-emitting device in which a light-emitting element such as an organic EL element is provided in each pixel, an electrophoretic display device, a digital micromirror device (DMD), a plasma display panel (PDP), or a field emission display (FED) can be used for the display portion 8002.

Note that the display device includes, in its category, all of information display devices for personal computers, advertisement displays, and the like, in addition to TV broadcast reception.

In FIG. 14, an installation lighting device 8100 is an example of an electrical appliance using a secondary battery 8103 of one embodiment of the present invention. Specifically, the installation lighting device 8100 includes a housing 8101, a light source 8102, the secondary battery 8103, and the like. Although FIG. 14 illustrates the case where the secondary battery 8103 is provided in a ceiling 8104 on which the housing 8101 and the light source 8102 are installed, the secondary battery 8103 may be provided in the housing 8101. The installation lighting device 8100 can receive power from a commercial power source. Alternatively, the installation lighting device 8100 can use power stored in the secondary battery 8103. Thus, the installation lighting device 8100 can be operated with the use of the secondary battery 8103 of one embodiment of the present invention as an uninterruptible power source even when power cannot be supplied from a commercial power source due to power failure or the like.

Note that although the installation lighting device 8100 provided in the ceiling 8104 is illustrated in FIG. 14 as an example, the secondary battery of one embodiment of the present invention can be used as an installation lighting device provided in, for example, a wall 8105, a floor 8106, a window 8107, or the like other than the ceiling 8104. Alternatively, the secondary battery can be used in a tabletop lighting device or the like.

As the light source 8102, an artificial light source which emits light artificially by using power can be used. Specifically, an incandescent lamp, a discharge lamp such as and a fluorescent lamp, and a light-emitting element such as an LED and an organic EL element are given as examples of the artificial light source.

In FIG. 14, an air conditioner including an indoor unit 8200 and an outdoor unit 8204 is an example of an electrical appliance using a secondary battery 8203 of one embodiment of the present invention. Specifically, the indoor unit 8200 includes a housing 8201, an air outlet 8202, the secondary battery 8203, and the like. Although FIG. 14 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can receive power from a commercial power source. Alternatively, the air conditioner can use power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power source even when power cannot be supplied from a commercial power source due to power failure or the like.

Note that although the split-type air conditioner including the indoor unit and the outdoor unit is illustrated in FIG. 14 as an example, the secondary battery of one embodiment of the present invention can be used in an air conditioner in which the functions of an indoor unit and an outdoor unit are integrated in one housing.

In FIG. 14, an electric refrigerator-freezer 8300 is an example of an electrical appliance using a secondary battery 8304 of one embodiment of the present invention. Specifically, the electric refrigerator-freezer 8300 includes a housing 8301, a door for a refrigerator 8302, a door for a freezer 8303, the secondary battery 8304, and the like. The secondary battery 8304 is provided inside the housing 8301 in FIG. 14. The electric refrigerator-freezer 8300 can receive power from a commercial power source. Alternatively, the electric refrigerator-freezer 8300 can use power stored in the secondary battery 8304. Thus, the electric refrigerator-freezer 8300 can be operated with the use of the secondary battery 8304 of one embodiment of the present invention as an uninterruptible power source even when power cannot be supplied from a commercial power source due to power failure or the like.

Note that among the electrical appliances described above, a high-frequency heating apparatus such as a microwave oven and an electrical appliance such as an electric rice cooker require high power in a short time. The tripping of a circuit breaker of a commercial power source in use of electrical appliances can be prevented by using the secondary battery of one embodiment of the present invention as an auxiliary power source for supplying power which cannot be supplied enough by a commercial power source.

In addition, in a time period when electrical appliances are not used, particularly when the proportion of the amount of power which is actually used to the total amount of power which can be supplied from a commercial power source (such a proportion referred to as a usage rate of power) is low, power can be stored in the secondary battery, whereby the usage rate of power can be reduced in a time period when the electrical appliances are used. For example, in the case of the electric refrigerator-freezer 8300, power can be stored in the secondary battery 8304 in night time when the temperature is low and the door for a refrigerator 8302 and the door for a freezer 8303 are not often opened and closed. On the other hand, in daytime when the temperature is high and the door for a refrigerator 8302 and the door for a freezer 8303 are frequently opened and closed, the secondary battery 8304 is used as an auxiliary power source; thus, the usage rate of power in daytime can be reduced.

This embodiment can be implemented combining with any of the other embodiments as appropriate.

### Embodiment 4

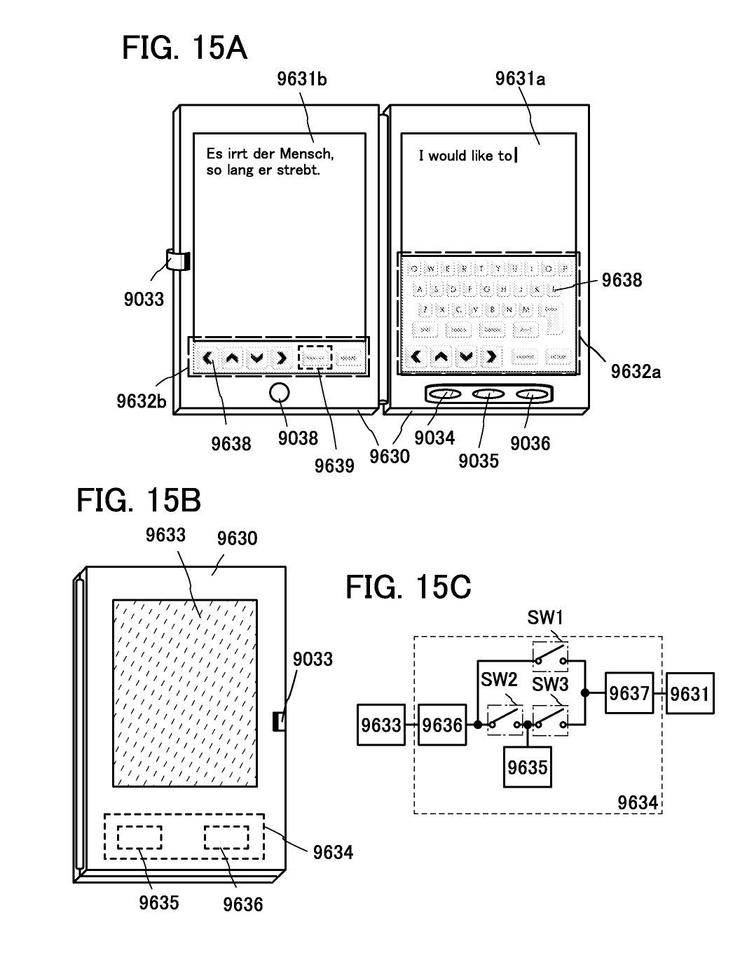

Next, a portable information terminal which is an example of an electrical appliance is described with reference to FIGS. 15A to 15C.

FIGS. 15A and 15B illustrate a tablet terminal that can be folded. FIG. 15A illustrates the tablet terminal in the state of being unfolded. The tablet terminal includes a housing 9630, a display portion 9631a, a display portion 9631b, a switch 9034 for switching display modes, a power switch 9035, a switch 9036 for switching to power-saving-mode, a fastener 9033, and an operation switch 9038.

Part of the display portion 9631a can be a touch panel region 9632a and data can be input when a displayed operation key 9638 is touched. Note that FIG. 15A illustrates, as an example, that half of the area of the display portion 9631a has only a display function and the other half of the area has a touch panel function. However, the structure of the display portion 9631a is not limited to this, and all the area of the display portion 9631a may have a touch panel function. For example, all the area of the display portion 9631a can display keyboard buttons and serve as a touch panel while the display portion 9631b can be used as a display screen.

Like the display portion 9631a, part of the display portion 9631b can be a touch panel region 9632b. When a finger, a stylus, or the like touches the place where a button 9639 for switching to keyboard display is displayed in the touch panel, keyboard buttons can be displayed on the display portion 9631b.

Touch input can be performed on the touch panel regions 9632a and 9632b at the same time.

The switch 9034 for switching display modes can switch the display between portrait mode, landscape mode, and the like, and between monochrome display and color display, for example. With the switch 9036 for switching to power-saving mode, the luminance of display can be optimized depending on the amount of external light at the time when the tablet terminal is in use, which is detected with an optical sensor incorporated in the tablet terminal. The tablet terminal may include another detection device such as a sensor for detecting orientation (e.g., a gyroscope or an acceleration sensor) in addition to the optical sensor.

Although the display area of the display portion 9631a is the same as that of the display portion 9631b in FIG. 15A, one embodiment of the present invention is not particularly limited thereto. The display area of the display portion 9631a may be different from that of the display portion 9631b, and further, the display quality of the display portion 9631a may be different from that of the display portion 9631b. For example, one of them may be a display panel that can display higher-definition images than the other.

FIG. 15B illustrates the tablet terminal in the state of being closed. The tablet terminal includes the housing 9630, a solar cell 9633, a charge and discharge control circuit 9634, a battery 9635, and a DCDC converter 9636. Note that FIG. 15B illustrates an example in which the charge and discharge control circuit 9634 includes the battery 9635 and the DCDC converter 9636, and the battery 9635 includes the secondary battery described in any of the above embodiments.

Since the tablet can be folded, the housing 9630 can be closed when the tablet terminal is not in use. Thus, the display portions 9631a and 9631b can be protected, thereby providing a tablet terminal with excellent endurance and excellent reliability for long-term use.

The tablet terminal illustrated in FIGS. 15A and 15B can also have a function of displaying various kinds of data (e.g., a still image, a moving image, and a text image), a function of displaying a calendar, a date, the time, or the like on the display portion, a touch-input function of operating or editing data displayed on the display portion by touch input, a function of controlling processing by various kinds of software (programs), and the like.

The solar cell 9633, which is attached on the surface of the tablet terminal, supplies power to the touch panel, the display portion, a video signal processor, and the like. Note that the solar cell 9633 is preferably provided on one or two surfaces of the housing 9630, in which case the battery 9635 can be charged efficiently. The use of the secondary battery of one embodiment of the present invention as the battery 9635 has advantages such as a reduction is size.

The structure and operation of the charge and discharge control circuit 9634 illustrated in FIG. 15B are described with reference to a block diagram in FIG. 15C. The solar cell 9633, the battery 9635, the DCDC converter 9636, a converter 9637, switches SW1 to SW3, and the display portion 9631 are illustrated in FIG. 15C, and the battery 9635, the DCDC converter 9636, the converter 9637, and the switches SW1 to SW3 correspond to the charge and discharge control circuit 9634 illustrated in FIG. 15B.

First, an example of the operation in the case where power is generated by the solar cell 9633 using external light is described. The voltage of power generated by the solar cell is raised or lowered by the DCDC converter 9636 so that the power has a voltage for charging the battery 9635. Then, when the power from the solar cell 9633 is used for the operation of the display portion 9631, the switch SW1 is turned on and the voltage of the power is raised or lowered by the converter 9637 so as to be a voltage needed for the display portion 9631. In addition, when display on the display portion 9631 is not performed, the switch SW1 may be turned off and the switch SW2 may be turned on so that the battery 9635 is charged.

Here, the solar cell 9633 is described as an example of a power generation means; however, there is no particular limitation on the power generation means, and the battery 9635 may be charged with another power generation means such as a piezoelectric element or a thermoelectric conversion element (Peltier element). For example, the battery 9635 may be charged with a non-contact power transmission module that transmits and receives power wirelessly (without contact) to charge the battery or with a combination of other charging means.

It is needless to say that one embodiment of the present invention is not limited to the electrical appliance illustrated in FIGS. 15A to 15C as long as the electrical appliance is equipped with the secondary battery described in any of the above embodiments.

### Embodiment 5

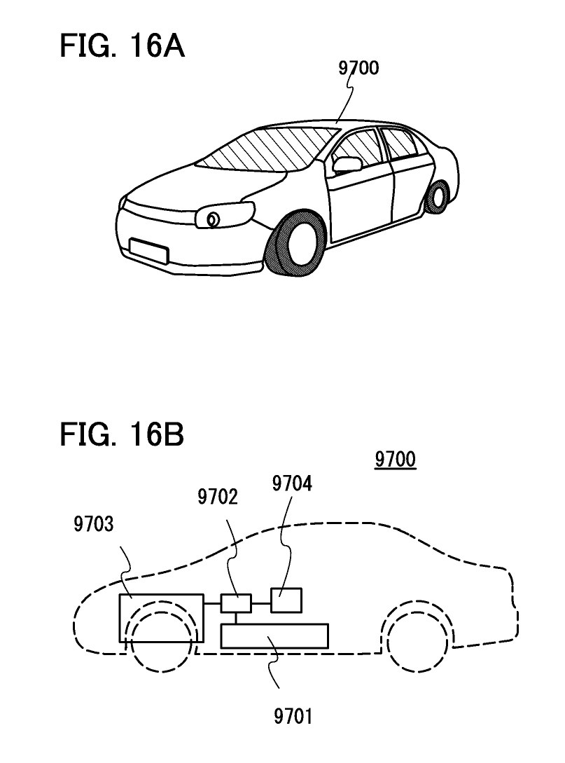

Further, an example of the moving object which is an example of the electrical appliance is described with reference to FIGS. 16A and 16B.

Any of the secondary batteries described in Embodiment 1 or 2 can be used as a control battery. The control battery can be externally charged by electric power supply using a plug-in technique or contactless power feeding. Note that in the case where the moving object is an electric railway vehicle, the electric railway vehicle can be charged by electric power supply from an overhead cable or a conductor rail.

FIGS. 16A and 16B illustrate an example of an electric vehicle. An electric vehicle 9700 is equipped with a secondary battery 9701. The output of the power of the secondary battery 9701 is adjusted by a control circuit 9702 and the power is supplied to a driving device 9703. The control circuit 9702 is controlled by a processing unit 9704 including a ROM, a RAM, a CPU, or the like which is not illustrated.

The driving device 9703 includes a DC motor or an AC motor either alone or in combination with an internal-combustion engine. The processing unit 9704 outputs a control signal to the control circuit 9702 based on input data such as data on operation (e.g., acceleration, deceleration, or stop) by a driver of the electric vehicle 9700 or data on driving the electric vehicle 9700 (e.g., data on an upgrade or a downgrade, or data on a load on a driving wheel). The control circuit 9702 adjusts the electric energy supplied from the secondary battery 9701 in accordance with the control signal of the processing unit 9704 to control the output of the driving device 9703. In the case where the AC motor is mounted, although not illustrated, an inverter which converts direct current into alternate current is also incorporated.

The secondary battery 9701 can be charged by external electric power supply using a plug-in technique. For example, the secondary battery 9701 is charged through a power plug from a commercial power source. The secondary battery 9701 can be charged by converting external power into DC constant voltage having a predetermined voltage level through a converter such as an ACDC converter. When the secondary battery of one embodiment of the present invention is provided as the secondary battery 9701, a shorter charging time can be brought about and improved convenience can be realized. Moreover, the higher charge and discharge rate of the secondary battery 9701 can contribute to greater acceleration and excellent performance of the electric vehicle 9700. When the secondary battery 9701 itself can be made compact and lightweight with improved characteristics of the secondary battery 9701, the vehicle can be made lightweight, leading to an increase in fuel efficiency.

This embodiment can be implemented combining with any of the other embodiments as appropriate.

### Example 1

The present invention is described in detail below with Example and Comparative Example. Note that the present invention is not limited to Example below.

### (Manufacture of Negative Electrode)

A 0.7-mm-thick sheet-like titanium (hereinafter referred to as a titanium sheet) was used as a negative electrode current collector. The purity of the titanium is 99.5%.

A photoresist pattern was formed over the titanium sheet, and then a surface of the titanium sheet which was exposed from the photoresist was etched by a dry etching method. The etching was performed for 440 seconds under the following conditions. The power of source (13.56 MHz) is 1000 W, the power of bias (3.2 MHz) is 80 W, the pressure is 0.67 Pa, the etching gas is a mixed gas of BCl₃ and Cl₂ with flow rates of 150 sccm and 50 sccm, respectively, and the substrate temperature is −10° C. Through the etching, the negative electrode current collector including a base portion and protrusion portions was formed.

Then, 500-nm-thick amorphous silicon serving as a negative electrode active material layer was formed over the negative electrode current collector with a reduced-pressure CVD apparatus. An amorphous silicon layer was deposited for 2 hours and 20 minutes by introducing monosilane (SiH₄) and nitrogen (N₂) into a reaction chamber at flow rates of 300 sccm at a pressure of 100 Pa and a substrate temperature of 550° C. Thus, negative electrode protrusion portions including the protrusion portions of the negative electrode current collector as cores and a negative electrode base portion including the base portion of the negative electrode current collector and the negative electrode active material layer thereover were formed.

Next, a solution containing a high molecular material was applied over the negative electrode protrusion portions and the negative electrode base portion. An SBR dispersion liquid was used as the high molecular material. The SBR dispersion liquid is formed by dissolving random copolymer particles in water. The random copolymer particle is represented by the following chemical formula and contains a small amount of acrylic ester or organic acid having styrene and butadiene as skeletons.

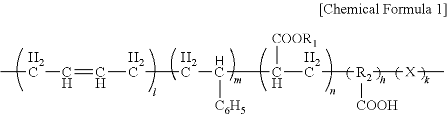

The titanium sheet including the negative electrode protrusion portions was set in an evacuated bell jar and heated at approximately 70° C. and then, the SBR dispersion liquid was dropped onto the titanium sheet in this state. After the SBR dispersion liquid was dropped, the pressure was reduced while remaining the temperature at approximately 70° C. and the titanium sheet was dried for several minutes. Since the amount of the sample was increased by 0.2 mg after the drying, a 0.2 mg of SBR was probably applied. Although the series of steps were performed only once, the series of steps may be performed twice or more to make the thickness of the high molecular material layer uniform. Through the above-described steps, the high molecular material layer was formed over the basal portions of the negative electrode protrusion portions and the negative electrode base portion.

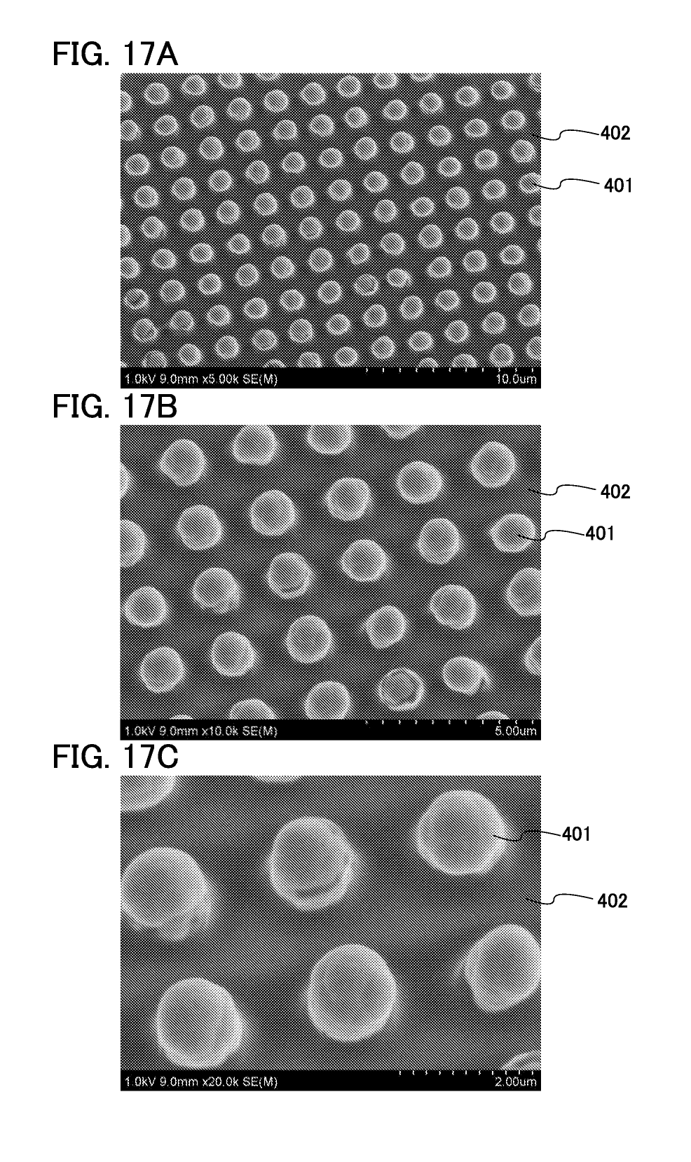

FIGS. 17A to 17C are observation photographs of the manufactured negative electrode. FIGS. 17A to 17C are bird's-eye images of the manufactured negative electrode observed by a scanning electron microscope (SEM). The images are scaled up from FIGS. 17A to 17C. A plurality of negative electrode protrusion portions 401 part of which is covered with amorphous silicon and which is regularly arranged can be observed. In addition, the high molecular material layer 402 surrounding the negative electrode protrusion portions 401 can be observed. The negative electrode protrusion portions 401 except their top portions and the peripheries thereof are embedded in the high molecular material layer 402. Therefore, carrier ions are inserted into the negative electrode active material layer included in the negative electrode protrusion portions 401 only through the peripheries of the exposed top portions of the negative electrode protrusion portions 401 which is observed in the SEM image.

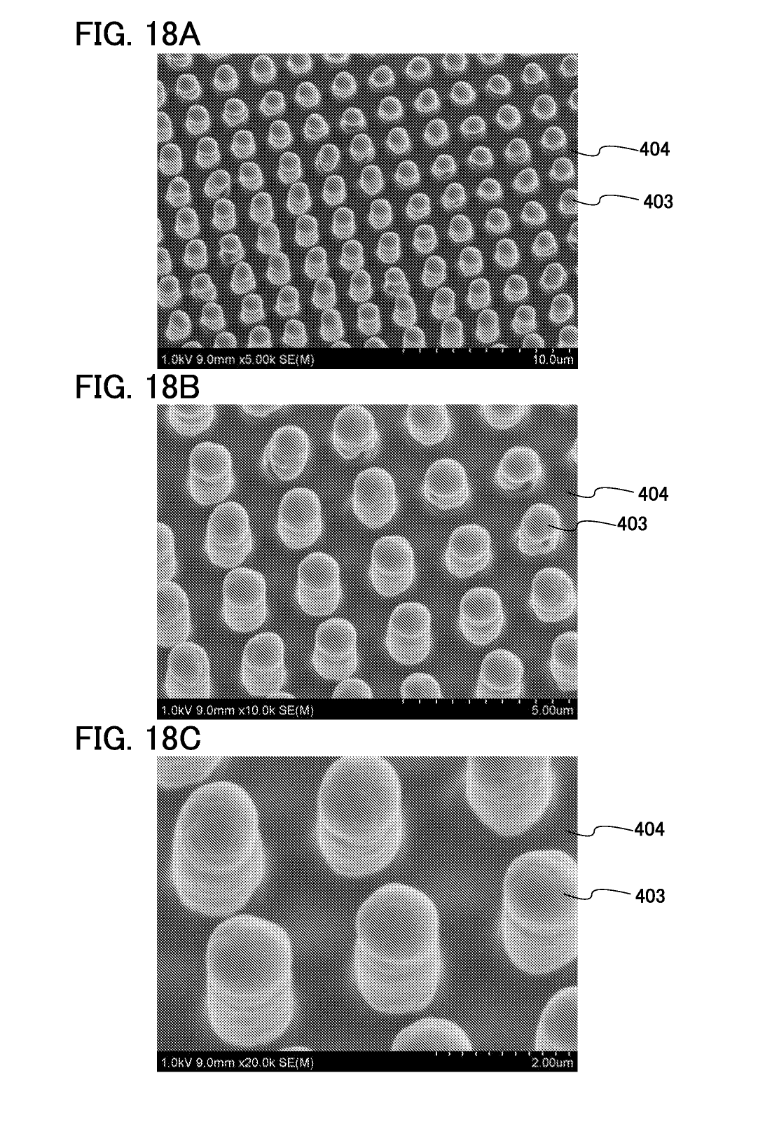

Similarly, FIGS. 18A to 18C are SEM images of a negative electrode which includes a plurality of negative electrode protrusion portions 403 and in which a high molecular material layer 404 is applied. Large parts of side surfaces of the negative electrode protrusion portions 403 are exposed because the high molecular material layer 404 has a small thickness, which is different from the negative electrode shown in FIGS. 17A to 17C. However, the basal portions of the negative electrode protrusion portions 403 are covered with the high molecular material layer 404; thus, it is possible to suppress direct insertion of carrier ions into a negative electrode base portion.

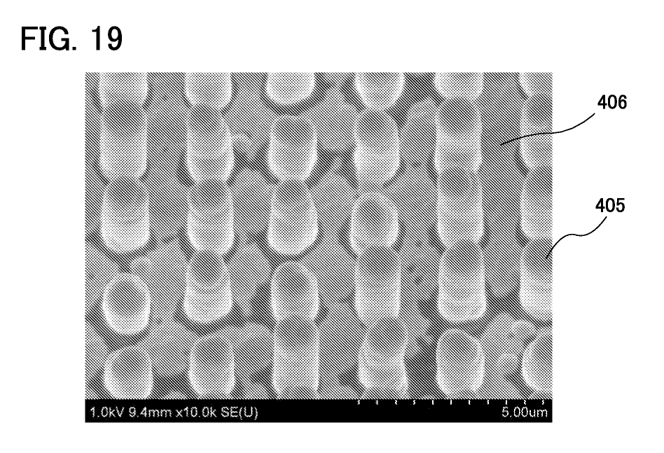

Note that FIG. 19 is also a SEM image of a negative electrode which includes a plurality of negative electrode protrusion portions 405 and in which a high molecular material layer 406 is applied. The negative electrode in FIG. 19 is different from the negative electrodes in FIGS. 17A to 17C and FIGS. 18A to 18C in that the high molecular material layer 406 has extremely small thickness. For this reason, there are some regions which are not covered with the high molecular material layer 406 (black portions in the SEM image). In addition, the basal portions of the negative electrode protrusion portions 405 are not covered because the thickness of the high molecular material layer 406 is insufficient. In such a case, carrier ions are occluded in a negative electrode active material layer in a negative electrode base portion, which causes separation due to expansion and contraction of a negative electrode active material.

### (Battery Characteristics)

Characteristics of a battery including the negative electrode of one embodiment of the present invention which was manufactured in the above-described manner were measured. The characteristics were measured using a two-electrode cell in which lithium was used for a counter electrode. An electrolyte solution was formed by dissolving lithium hexafluorophosphate (LiPF₆) dissolved at a concentration of 1 mol/L in a solution in which ethylene carbonate (EC) and diethyl carbonate (DEC) were mixed at a volume ratio of 1:1. The first charge and discharge were performed at a rate of 0.05 C (20 hours is required for charging) (CC—CV), and the second and subsequent charges and discharges were performed at a rate of 0.25 C (4 hours is required for charging) (CC). Note that measurement was performed in a range of 0 mAh/g to 2100 mAh/g at which discharge capacity is half of the theoretical capacity of silicon.

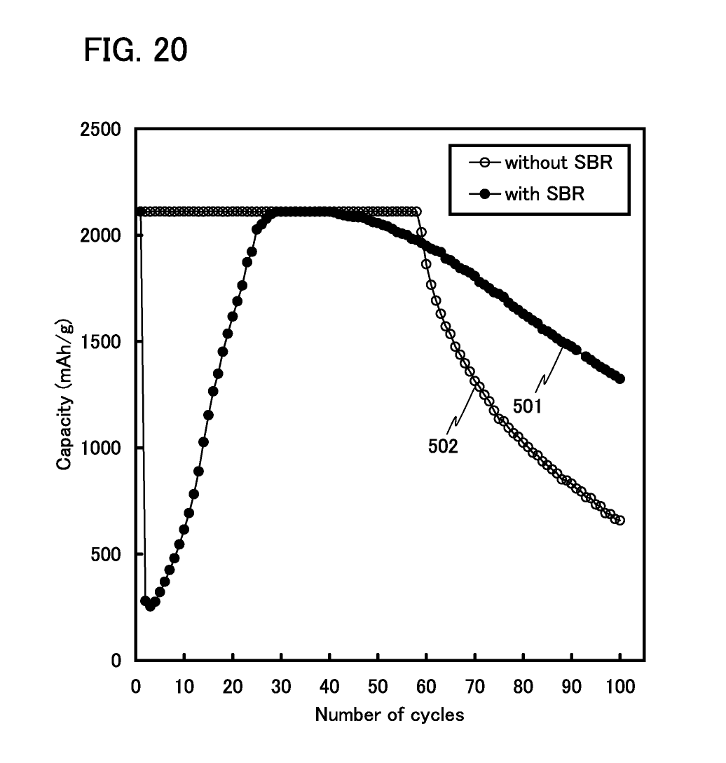

FIG. 20 shows results of the measurement of the characteristics. The vertical axis represents the capacity of the negative electrode (unit: mAh/g) and the horizontal axis represents the number of charge and discharge cycles. A curve 501 shows measurement results of the cycle characteristics of the negative electrode manufactured as described above in which large parts of the negative electrode protrusion portions are embedded in the SBR dispersion liquid used as the high molecular material layer. Although decreasing in the initial cycle, the capacity increases to have a desired value around the 30th cycle. The capacity decreases little by little after the 40th cycle; however, the negative electrode keeps having the capacity higher than the theoretical capacity of carbon (black lead).

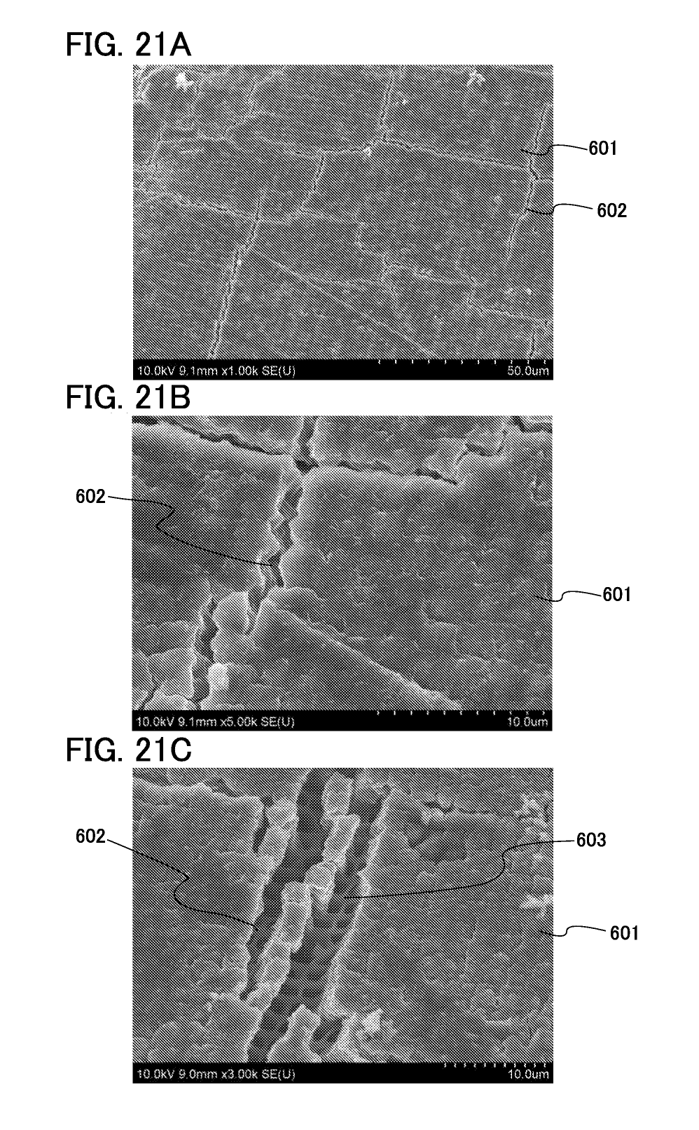

FIGS. 21A to 21C are SEM images of the state of the negative electrode after the measurement of the cycle characteristics. FIG. 21A is the bird's-eye SEM image of the surface of the negative electrode and part of FIG. 21A is magnified to obtain the SEM image in FIG. 21B. Silicon of a negative electrode protrusion portion 601 is not in a protrusion shape and expanded due to the repeated charges and discharges. However, although some cracks 602 are observed in the surface of the negative electrode, great damage which causes separation of the negative electrode active material is not observed.

Note that FIG. 21C is the SEM image of a different portion from those in FIGS. 21A and 21B on the same surface as those in FIGS. 21A and 21B. Although the cracks 602 cleave the negative electrode protrusion portion 601, only the high molecular material layer 603 is observed in each of the cracks 602. The high molecular material layer is observed as a lattice including openings which is extended in the horizontal direction. Considering that the negative electrode protrusion portions are arranged vertically and horizontally at regular intervals when the negative electrode was manufactured, the high molecular material layer 603 formed of the SBR was probably extended in the horizontal direction owing to its elasticity when the surface of the negative electrode was cleaved in the horizontal direction and the cracks 602 were generated. Therefore, it is probable that the cleaved surface of the negative electrode is connected because of the elasticity of the high molecular material layer 603, and thus separation of the negative electrode active material from the base portion or the protrusion portions of the negative electrode current collector is suppressed.

### Comparative Example

Further, to evaluate the negative electrode of one embodiment of the present invention, as a comparative example, characteristics of a battery including a negative electrode in which a high molecular material layer was not provided were measured. The negative electrode was manufactured by the same manufacturing method to have the same structure as the above-described negative electrode except that the high molecular material layer was not formed. That is, a 0.7-mm-thick titanium sheet which is the same as described above was used. Further, as a negative electrode active material layer, thin-film amorphous silicon with a thickness of approximately 500 nm was formed by a reduced-pressure CVD method under the same conditions described above. In FIG. 20, a curve 502 shows measurement results in this comparative example. The measurement results show that although the negative electrode has the capacity which is kept at 2100 mAh/g until the 60th cycle, the capacity significantly decreases after the 60th cycle. This significant decrease in the capacity probably results from peeling of silicon from the negative electrode current collector which is caused by expansion and contraction of the silicon because of the repeated charges and discharges.

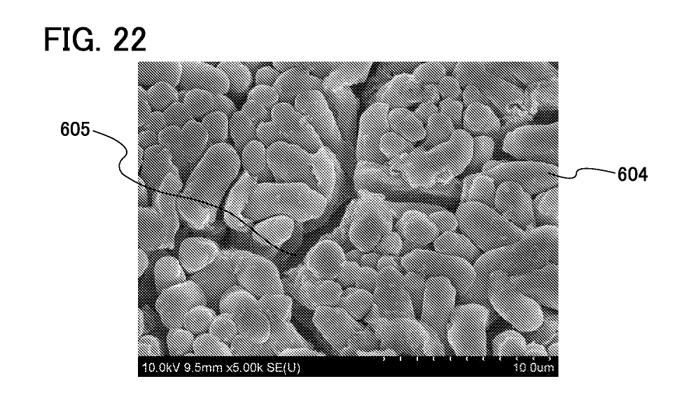

After the charges and discharges, in a surface of the negative electrode which does not include the high molecular material layer and is used as the comparative example, negative electrode protrusion portions 604 are made into groups and partitioned from each other by cracks 605, and thus the separation is taken place, as shown in a SEM image in FIG. 22.

### (Evaluation)

As a result, it is found that in the comparative example in which the negative electrode base portion and the periphery of the basal portions of the negative electrode protrusion portions are not coated with the high molecular material layer, a drastic decrease in the capacity starts at a certain number of cycle. On the other hand, in the case of using the negative electrode of one embodiment of the present invention, a drastic decrease in the capacity can be suppressed. From this comparison, it is found that a negative electrode for a secondary battery having high charge and discharge capacity and little deterioration due to charge and discharge can be provided by covering a negative electrode base portion and part of negative electrode protrusion portions including basal portions thereof with a high molecular material layer formed using SBR or the like.

This application is based on Japanese Patent Application serial No. 2012-049232 filed with Japan Patent Office on Mar. 6, 2012, the entire contents of which are hereby incorporated by reference.

What is claimed is:

1. A negative electrode for a secondary battery comprising:
a current collector including a base portion and protrusion portions which are connected to the base portion and extend in a direction substantially perpendicular to a top surface of the base portion;
an active material layer; and
a high molecular material layer,
wherein the base portion and the protrusion portions comprise a same material,
wherein top surfaces and side surfaces of the protrusion portions are covered with the active material layer to form negative electrode protrusion portions,
wherein the top surface of the base portion is covered with the active material layer to form a negative electrode base portion, and
wherein part of side surfaces of the negative electrode protrusion portions including basal portions thereof and a top surface of the negative electrode base portion are covered with the high molecular material layer.

2. The negative electrode for a secondary battery according to claim 1, wherein the material of the protrusion portions and the base portion is a conductive material containing titanium.

3. The negative electrode for a secondary battery according to claim 1, wherein the high molecular material layer comprises at least one of styrene-butadiene rubber (SBR), polyvinyl alcohol (PVA), styrene-isoprene-styrene rubber, acrylonitrile-butadiene rubber, butadiene rubber, ethylene-propylene-diene copolymer, polyimide, polyvinyl chloride, polytetrafluoroethylene, polyethylene, polypropylene, isobutylene, polyethylene terephthalate, nylon, carboxylmethyl cellulose (CMC), polyvinylidene fluoride (PVDF), polyacrylonitrile (PAN), polyethylene oxide (PEO), polystyrene, polyacrylic acid methyl, polymethylmethacrylate (PMMA), and polypropylene oxide.

4. The negative electrode for a secondary battery according to claim 1, wherein the part of the side surfaces of the negative electrode protrusion portions including the basal portions thereof corresponds to two-quarters or more and less than four-quarter of a height of the negative electrode protrusion portions.

5. The negative electrode for a secondary battery according to claim 1, wherein the active material layer comprises amorphous silicon, microcrystalline silicon, polycrystalline silicon, or a combination thereof.

6. The negative electrode for a secondary battery according to claim 1, wherein an aspect ratio of the protrusion portions is 0.2 or more and 2000 or less.

7. The negative electrode for a secondary battery according to claim 1, wherein a shape of the protrusion portions is a columnar shape, a conical shape, or a plate-like shape.

8. The negative electrode for a secondary battery according to claim 1, wherein a protective layer is provided between tips of the protrusion portions and the active material layer.

9. A secondary battery comprising the negative electrode for a secondary battery according to claim 1.

10. A method for manufacturing a negative electrode for a secondary battery, comprising the steps of:
forming a photoresist pattern over a current collector material;
forming a current collector including a base portion and protrusion portions by etching the current collector material using the photoresist pattern as a mask;
forming an active material layer over top surfaces and side surfaces of the protrusion portions and a top surface of the base portion, whereby a negative electrode protrusion portions which are the protrusion portions covered with the active material layer and a negative electrode base portion which is the base portion covered with the active material layer are formed; and
forming a high molecular material layer to cover part of side surfaces of the negative electrode protrusion portions including basal portions thereof and a top surface of the negative electrode base portion.

11. The method for manufacturing the negative electrode for a secondary battery according to claim 10, wherein the high molecular material layer is formed by applying a solution containing a high molecular material over the active material layer and drying the solution.

12. The method for manufacturing the negative electrode for a secondary battery according to claim 10, wherein the step of etching the current collector material is conducted by dry etching.

13. The method for manufacturing the negative electrode for a secondary battery according to claim 10, wherein the current collector material is a conductive material containing titanium.

14. The method for manufacturing the negative electrode for a secondary battery according to claim 10, wherein the part of the side surfaces of the negative electrode protrusion portions including the basal portions thereof corresponds to two-quarters or more and less than four-quarter of a height of the negative electrode protrusion portions.

15. The method for manufacturing the negative electrode for a secondary battery according to claim 10, wherein the active material layer comprises amorphous silicon, microcrystalline silicon, polycrystalline silicon, or a combination thereof.

16. A method for manufacturing a negative electrode for a secondary battery, comprising the steps of:
forming a protective layer over a current collector material;
forming a photoresist pattern over the protective layer;
etching the protective layer using the photoresist pattern as a mask;
forming a current collector including a base portion and protrusion portions by etching the current collector material using the etched protective layer as a mask;
forming an active material layer over top surfaces and side surfaces of the protrusion portions and a top surface of the base portion, whereby a negative electrode protrusion portions which are the protrusion portions covered with the active material layer and a negative electrode base portion which is the base portion covered with the active material layer are formed; and
forming a high molecular material layer to cover part of side surfaces of the negative electrode protrusion portions including basal portions thereof and a top surface of the negative electrode base portion.

17. The method for manufacturing the negative electrode for a secondary battery according to claim 16, wherein the high molecular material layer is formed by applying a solution containing a high molecular material over the active material layer and drying the solution.

18. The method for manufacturing the negative electrode for a secondary battery according to claim 16, further comprising the step of removing the photoresist pattern after etching the protective layer and before forming the current collector.

19. The method for manufacturing the negative electrode for a secondary battery according to claim 16, further comprising the step of removing the photoresist pattern after forming the current collector and before forming the active material layer.

20. The method for manufacturing the negative electrode for a secondary battery according to claim 16, wherein the step of etching the current collector material is conducted by dry etching.

21. The method for manufacturing the negative electrode for a secondary battery according to claim 16, wherein the current collector material is a conductive material containing titanium.

22. The method for manufacturing the negative electrode for a secondary battery according to claim 16, wherein the part of the side surfaces of the negative electrode protrusion portions including the basal portions thereof corresponds to two-quarters or more and less than four-quarter of a height of the negative electrode protrusion portions.

23. The method for manufacturing the negative electrode for a secondary battery according to claim 16, wherein the active material layer comprises amorphous silicon, microcrystalline silicon, polycrystalline silicon, or a combination thereof.
